(19) United States
(12) Patent Application Publication
(10) Pub. No.: US 2019/0108447 A1
(43) Pub. Date: Apr. 11, 2019

(54) MULTIFUNCTION PERCEPTRONS IN MACHINE LEARNING ENVIRONMENTS

(71) Applicant: Intel Corporation, Santa Clara, CA (US)

(72) Inventors: Michael Kounavis, Portland, OR (US); David Durham, Beaverton, OR (US)

(73) Assignee: Intel Corporation, Santa Clara, CA (US)

(21) Appl. No.: 16/204,549

(22) Filed: Nov. 29, 2018

Related U.S. Application Data
(60) Provisional application No. 62/592,921, filed on Nov. 30, 2017.

(51) Int. Cl. G06N 3/08; G06N 3/04

(52) U.S. Cl. CPC G06N 3/08; G06K 9/6256; G06N 3/088; G06N 3/04

(57) ABSTRACT

A mechanism is described for facilitating multifunction perceptron-based machine learning in computing environments, according to one embodiment. A method of embodiments, as described herein, includes generating a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

### CLAIM TO PRIORITY

This Patent Application claims the benefit of and priority to U.S. Provisional Patent Application No. 62/592,921, entitled MULTIFUNCTION PERCEPTRONS, by Michael Kounavis, et al., filed Nov. 30, 2017, the entire contents of which are incorporated herein by reference.

### FIELD

Embodiments described herein relate generally to data processing and more particularly to facilitate multifunction perceptron-based machine learning in computing environments.

### BACKGROUND

A large body of work exists on neural networks (NNs), such as deep neural networks (DNNs); however, conventional NN architectures are vulnerable to parasitic signals that can drive computing systems into undesirable behavior. Further, conventional NN architectures are incapable of achieving high precision and recall as such architectures require non-intuitive ad hoc type of engineering efforts to build and optimize.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a multifunction perceptron mechanism according to one embodiment.

FIG. 2 illustrates a multifunction perceptron mechanism according to one embodiment.

FIG. 3A illustrates a multifunction perceptron architecture according to one embodiment.

FIG. 3B illustrates logical to physical graphical mapping within a multifunction perceptron architecture according to one embodiment.

FIG. 4A illustrates a selector neuron according to one embodiment.

FIG. 4B illustrates edge feature extractor neurons for performing computations on a plurality of channels according to one embodiment.

FIG. 4C illustrates an equalized gradient magnitude signal used by edge feature extract neurons according to one embodiment.

FIG. 4D illustrates improved and configurable hysteresis employed by edge feature extractor neurons according to one embodiment.

FIG. 4E illustrates skin color using Gaussian mixture model-based ellipse regions according to one embodiment.

FIG. 4F illustrates a transaction sequence for detection of shape features realized using multifunction perceptrons according to one embodiment.

FIG. 4G illustrates a shape template according to one embodiment.

FIG. 5 illustrates a computer device capable of supporting and implementing one or more embodiments according to one embodiment.

FIG. 6 illustrates an embodiment of a computing environment capable of supporting and implementing one or more embodiments according to one embodiment.

FIG. 7 illustrates a machine learning software stack according to one embodiment.

FIG. 8A illustrates neural network layers according to one embodiment.

FIG. 8B illustrates computation stages associated with neural network layers according to one embodiment.

FIGS. 9A-9B illustrate functions of splitter neurons according to one embodiment.

FIGS. 9C-9D illustrate functions of mixer neurons according to one embodiment.

FIG. 9E illustrates features directed by counter neurons and their properties as a training process advances according to one embodiment.

FIG. 9F illustrates discovery of salient features through a learning process according to one embodiment.

FIG. 9G illustrates a contender algorithm considered for path connection within a multifunction perceptrons architecture according to one embodiment.

FIG. 9H illustrates competition between contender algorithms according to one embodiment.

FIG. 9I illustrates a learned algorithm according to one embodiment.

FIG. 10 illustrates a method for building a functional artificial intelligence system using a multifunction perceptrons architecture according to one embodiment.

### DETAILED DESCRIPTION

In the following description, numerous specific details are set forth. However, embodiments, as described herein, may be practiced without these specific details. In other instances, well-known circuits, structures and techniques have not been shown in detail in order not to obscure the understanding of this description.

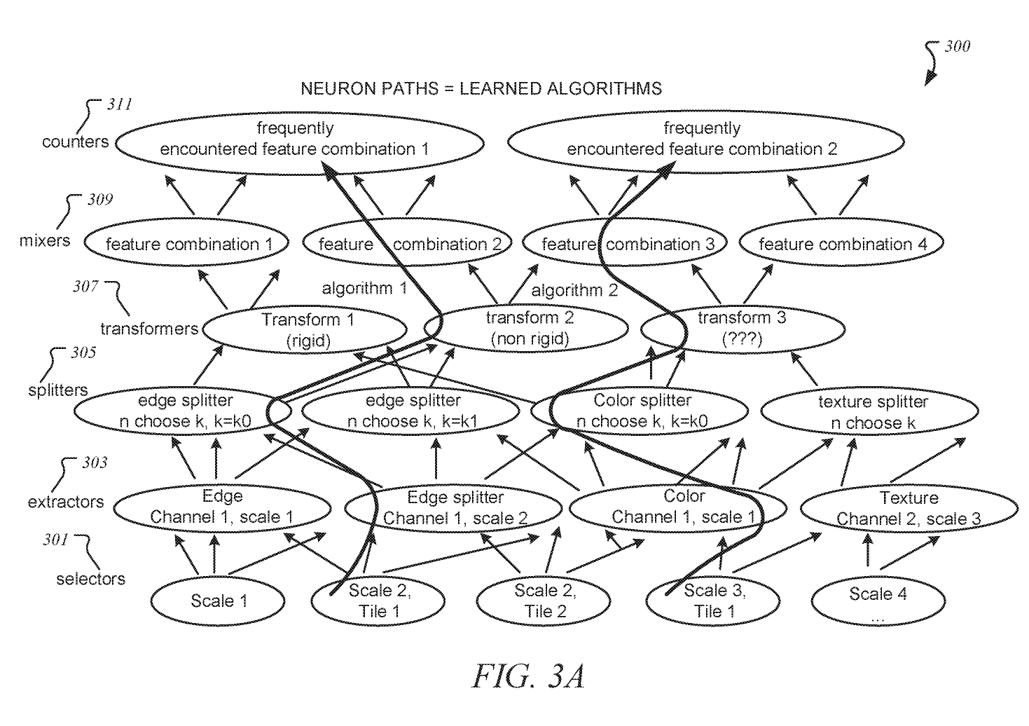

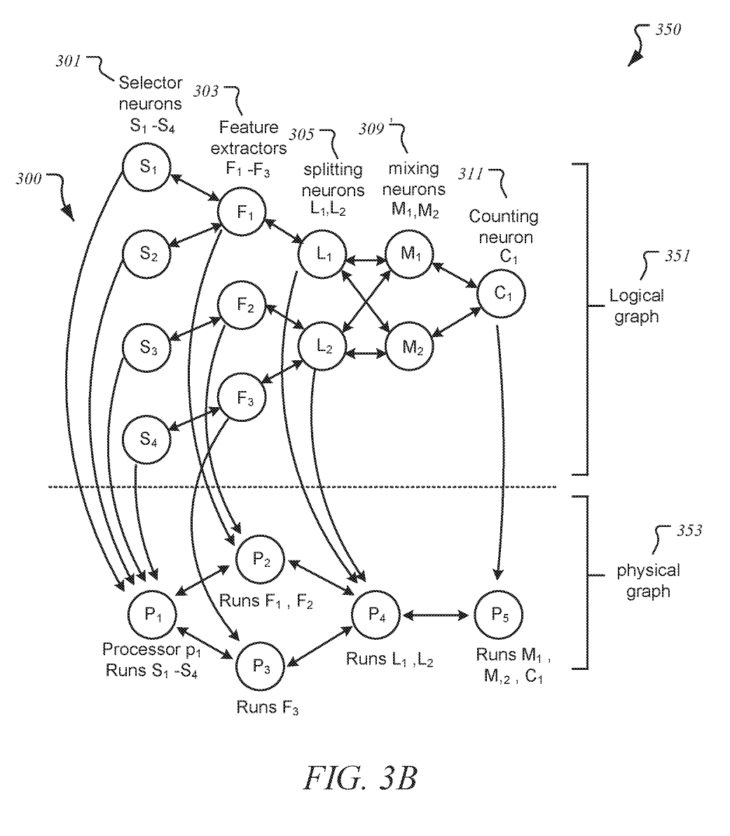

Embodiments provide for a novel technique to further provide for a novel multifunction perceptron (MP) architecture where neurons perform computations from a broader selection of compute functions other than just convolutions, while keeping the functions domain-specific to keep any and issues and their solution tractable. For example, training as shown in the architecture of FIG. 3A is no longer a non-linear optimization process; rather, it is a genetic algorithm-based process. In this process, multiple genetic candidate algorithms, which are input-output flows along neuron paths, compete in order to solve a given machine learning (ML) issues or perform an assigned ML task. In this way training becomes ‘survival of the fittest’ contest, where success is measured by the number of occurrences of features measured among all training data and along the various paths of the architecture.

It is contemplated that this novel technique, including the novel MP architecture, are not limited to software or hardware implementation and as will be further described in this document, this novel technique may be applied and implemented in software, hardware, or any combination thereof, such as firmware. For example, the mass amounts of generic compute operations performed by multifunction perceptrons may use processing cores more flexible than graphics processing units (GPUs) to be able to handle any amount of workload. Furthermore, any scoring or classification processes may be implemented using the learned algorithm and not the entire layered architecture, such as using custom accelerators, field-programable gate arrays (FPGAs), etc. For example, training may be performed using the novel MP architecture, while scoring may be done by simply implementing the learned algorithm. Further, this novel MP architecture may be viewed as a machine for generating highly complicated custom algorithms for addressing and solving specific tasks (e.g., face recognition, face detection, pedestrian detection, gesture recognition etc.).

It is contemplated that terms like “request”, “query”, “job”, “work”, “work item”, and “workload” may be referenced interchangeably throughout this document. Similarly, an “application” or “agent” may refer to or include a computer program, a software application, a game, a workstation application, etc., offered through an application programming interface (API), such as a free rendering API, such as Open Graphics Library (OpenGL®), DirectX® 11, DirectX® 12, etc., where “dispatch” may be interchangeably referred to as “work unit” or “draw” and similarly, “application” may be interchangeably referred to as “workflow” or simply “agent”. For example, a workload, such as that of a three-dimensional (3D) game, may include and issue any number and type of “frames” where each frame may represent an image (e.g., sailboat, human face). Further, each frame may include and offer any number and type of work units, where each work unit may represent a part (e.g., mast of sailboat, forehead of human face) of the image (e.g., sailboat, human face) represented by its corresponding frame. However, for the sake of consistency, each item may be referenced by a single term (e.g., “dispatch”, “agent”, etc.) throughout this document.

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as 3D games, augmented reality applications, etc.

It is to be noted that terms or acronyms like convolutional neural network (CNN), CNN, neural network (NN), NN, deep neural network (DNN), DNN, recurrent neural network (RNN), RNN, and/or the like, may be interchangeably referenced throughout this document. Further, terms like “autonomous machine” or simply “machine”, “autonomous vehicle” or simply “vehicle”, “autonomous agent” or simply “agent”, “autonomous device” or “computing device”, “robot”, and/or the like, may be interchangeably referenced throughout this document.

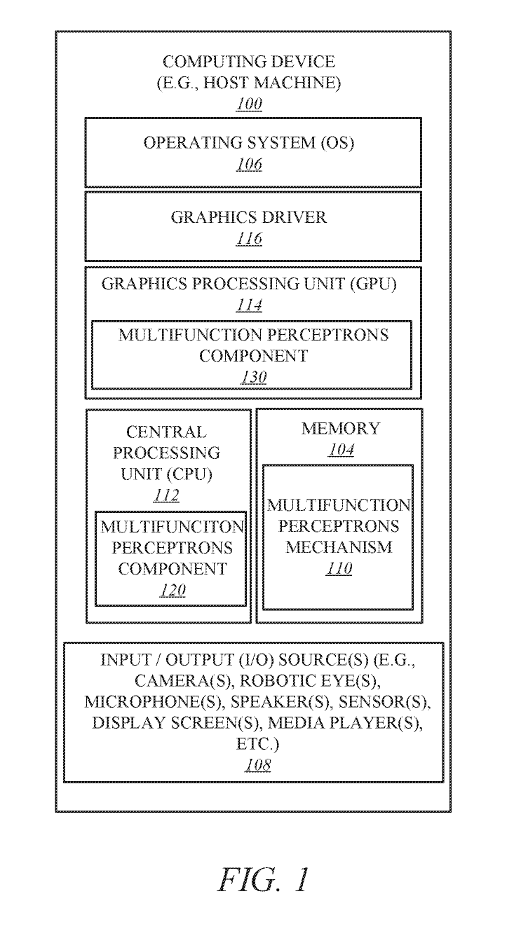

FIG. 1 illustrates a computing device 100 employing a multifunction preceptrons mechanism 110 according to one embodiment. Computing device 100 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet-based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip.

As illustrated, in one embodiment, computing device 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), UMD, user-mode driver framework (UMDF), UMDF, or simply “driver”) 116, central processing unit (“CPU” or simply “application processor”) 112, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, “element”, and “mechanism” may include, by way of example, software, hardware and/or a combination thereof, such as firmware.

In one embodiment, as illustrated, MP mechanism 110 may be hosted by memory 108 in communication with I/O source(s) 104, such as microphones, speakers, etc., of computing device 100. In another embodiment, MP mechanism 110 may be part of or hosted by operating system 106. In yet another embodiment, MP mechanism 110 may be hosted or facilitated by graphics driver 116. In yet another embodiment, MP mechanism 110 may be hosted by or part of graphics processing unit (“GPU” or simply graphics processor“) 114 or firmware of graphics processor 114; for example, MP mechanism 110 may be embedded in or implemented as part of the processing hardware of graphics processor 114, such as in the form of MP component 120. Similarly, in yet another embodiment, MP mechanism 110 may be hosted by or part of central processing unit (”CPU″ or simply “application processor”) 112; for example, MP mechanism 110 may be embedded in or implemented as part of the processing hardware of application processor 112, such as in the form of MP component 130.

It is contemplated that embodiments are not limited to certain implementation or hosting of MP mechanism 110 and that one or more portions or components of MP mechanism 110 may be employed or implemented as hardware, software, or any combination thereof, such as firmware.

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

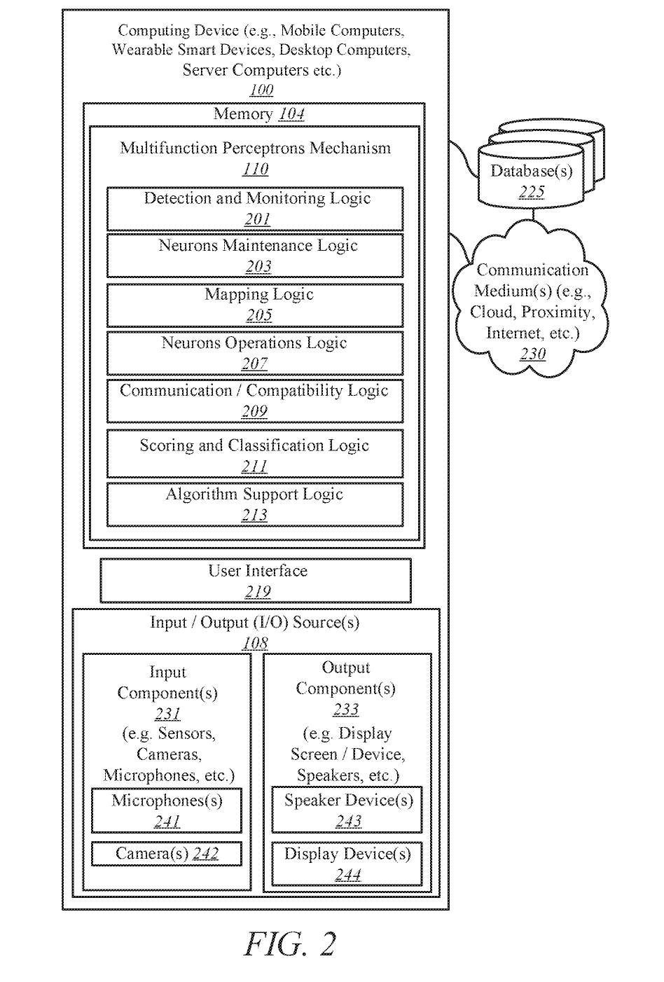

FIG. 2 illustrates multifunction perceptrons mechanism 110 of FIG. 1 according to one embodiment. For brevity, many of the details already discussed with reference to FIG. 1 are not repeated or discussed hereafter. In one embodiment, MP mechanism 110 may include any number and type of components, such as (without limitations): detection and monitoring logic 201; neurons maintenance logic 203; mapping logic 205; neurons operations logic 207; communication/compatibility logic 209; scoring and classification logic 211; and algorithm support logic 213.

Computing device 100 is further shown to include user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSense™ camera), sensors, microphone(s) 241, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O sources 108 including input component(s) 231 and output component(s) 233. In one embodiment, input component(s) 231 may include a sensor array including, but not limited to, microphone(s) 241 (e.g., ultrasound microphones), camera(s) 242 (e.g., two-dimensional (2D) cameras, three-dimensional (3D) cameras, infrared (IR) cameras, depth-sensing cameras, etc.), capacitors, radio components, radar components, scanners, and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, “element”, and “mechanism” may include, by way of example, software or hardware and/or a combination thereof, such as firmware. For example, logic may itself be or include or be associated with circuitry at one or more devices, such as MP component 130 and/or MP component 120 hosted by application processor 112 and/or graphics processor 114, respectively, of FIG. 1 having to facilitate or execute the corresponding logic to perform certain tasks.

For example, as illustrated, input component(s) 231 may include any number and type of microphones(s) 241, such as multiple microphones or a microphone array, such as ultrasound microphones, dynamic microphones, fiber optic microphones, laser microphones, etc. It is contemplated that one or more of microphone(s) 241 serve as one or more input devices for accepting or receiving audio inputs (such as human voice) into computing device 100 and converting this audio or sound into electrical signals. Similarly, it is contemplated that one or more of camera(s) 242 serve as one or more input devices for detecting and capturing of image and/or videos of scenes, objects, etc., and provide the captured data as video inputs into computing device 100.

As previously described, conventional NN architectures, such as DNN architectures, are brittle in nature and although DNNs are somewhat successful in achieving superior classification and synthetic data generation results when compared to other machine learning techniques, they are vulnerable to the presence of malicious visual signals (whether they be digital or analog). Such signals are typically subtle and inconspicuous and may drive the behavior of DNNs into undesired outcomes. Understanding what neurons learn and attaching physical meaning to the state of neurons in a predictable and repeatable way is arguably difficult along with having the need for resilient ML algorithms Embodiments provide for a novel technique for achieving virtually 100% precision and recall by ML algorithms is preferable and relevant (e.g., by malware detectors, autonomous vehicles, smart home environments, etc.).

First, the main processing stage for conventional DNNs is simple and homogeneous across neurons. This is a single convolution operation, or a small number of different convolutions (as in GoogleNets), followed by non-linear function processing. Convolution typically results in some information loss. For example, in some cases, such information loss may be of some relevance, such as for being the reason for having “bypassing” synapses (e.g., Residual Network (ResNet) architecture). Second, layer-by-layer stochastic gradient descent may not itself cope with overfitting, insufficient training data, or machine learning/machine teaching attacks. Other techniques, which are rather ad-hoc, such as dropout, momentum, batch normalization and Xavier initialization are needed for successful operations of DNNs.

Embodiments provide for a novel technique for addressing the above-mentioned issues by offering a novel computing model for neural networks where neurons are highly heterogeneous, while training is performed in a different manner Training is no longer a non-linear optimization process, but a process where multiple candidate algorithms compete with each other in order to solve a given problem or perform a given task. After a “survival-of-the-fittest” contest completes, the winning algorithm is selected for performing the task. The work draws from the observation that the human brain, contrary to common homogeneous artificial neural networks, contains in the order of a thousand varying types of neurons. Embodiments also consider other trends in neuron architectures, where architectures with alternative compute models, other than convolution-based ones, are being proposed.

Embodiments provide for a novel technique that further provides for a novel neural network architecture that uses digital implementation-based algorithms for the internals of the neurons and innovate in top of these by offering a novel procedure that can compose higher level algorithms for solving specific tasks using various heterogeneous lower level primitives.

Multifunction Perceptron Architecture

As supported by MP mechanism 110 and/or one or more of MP components 120, 130 of FIG. 1, a novel MP architecture is offered to perform various ML and deep learning (DL) functions are efficiently performed using various neurons. For example, considering architectures where neurons are used to perform computations from a broader selection of compute functions other than just convolutions. Moreover, functions can be domain-specific in order to keep any problems and their solution tractable.

In one embodiment, in this novel MP architecture, class features are learned dynamically as in standard DNNs, which means there remains no need to employ any fixed rule-based mechanism. Learning, however, may be performed in a manner that is potentially more predictable and more open to white box analysis and refinement, such as when a classification result and a confidence level are is returned by this novel MP architecture, it further returns any information about the reasons as to why certain decision was taken. Such information can be concise, quantifiable, and interpretable. In the following text, this document further describes the novel MP architecture and any neuron functions in the context of visual applications.

In one embodiment, detection and monitoring logic 201 may be used for detection and monitoring of various neurons within the MP architecture, such as MP architecture 300 of FIG. 3A, while neuron maintenance logic 201 performs other neuron-related tasks. For example, referring to FIG. 3A, neurons management logic 203 may be used to manage various classes of neurons 301, 303, 305, 307, 309, 311, such as selectors 301 for selecting subsets of an input image, where these “selector neurons” or “selecting neurons” or simply “selectors” 301 perform image pyramid computations, such as for which compute a scale space representation of an image may be supported by selectors 301, while other neurons, such as splitters 305, split the image into tiles. Terms like “splitter”, “splitting neuron”, and “splitter neuron” are used interchangeably throughout this document.

Similarly, as second class of neurons, such as extractors 303, are used to compute ‘raw’ visual features from the outputs of selectors 301. Extractor neurons or simply extractors 303 may be used to support versatile edge detection, where edges may be computed on various channels and at various visual scales using various adaptable thresholds. Similarly, color patterns may be computed from various channels, using various thresholds and implementing various modeling techniques, while texture pattern detection may also be supported by extractors 303.

In one embodiment, a third class of neurons, such as splitters 305, operate on the outputs received from extractors 303. Splitters 305 are used for partitioning the raw features computed by the extractor neurons or simply extractors 303 into components. For example, splitters 305 provide for class salient features that may just be present in parts of the output of extractors 303 and not in their whole output. For example, the edge information associated with a car's wheels may be combined with other irrelevant background edge information, where the relevant information can be isolated by split neurons or simply splitters 305. Further, for example, splitters 305 may be used to implement an n-choose-k splitting technique for various values of k.

A fourth class of neurons managed by neuron management logic 203 includes transformer neurons or simply transformers 307 for implementing further transformations on the raw feature components returned by splitters 305. Further, transformers 307 may be used for supporting several different visual transforms including (but not limited to) rigid transforms, non-rigid transforms, dimensionality reduction, lighting and contrast adjustments, etc.

As further illustrated with respect to FIG. 3A, a fifth class of neurons managed by neuron management logic 203 includes “mixing neurons” or “mixer neurons” or simply “mixers” 309 for combining the processed feature components returned by transformers 307 together into feature combinations. For example, a detected octagonal shape for a stop sign may be combined with a prevalent red color of this sign into a feature combination by these mixers 309. Mixers 309 are used for combining features of varying types, such as a color with edge-based features, or a color with edge-based features and texture-based features to aid a learning process, etc. Terms like “mixer”, “mixing neuron”, and “mixer neuron” are used interchangeably throughout this document.

A sixth and final class of neurons, such as counter neurons or simply counters 311, may be used for computing frequencies of feature combination appearances over all of the training data. Stated differently, counters 311 seek the most frequently encountered feature combinations, where such feature combinations include features that can define a trained object class. For example, a learned class feature may be the rule that “all cars have four wheels”. Other examples may include “each table has four legs” or “every tree has colors from a specific palette of green, brown, and earth tones”, etc.

As discussed, neurons management logic 203 may be used to manage each of the neurons mentioned above; however, embodiments are not limited to only the six types of neurons mentioned in this document and therefore, neurons management logic 203 may be further used to modify the types of neurons where, for example, one or more types of neurons are added to the fold and/or one or more type of neurons are removed.

Further, in one embodiment, neurons operations logic 207, as will be further described later, may be used to facilitate the neurons to perform their tasks, such as each neuron type may be facilitated to perform one or more tasks that it is responsible for performing, such as training, learning, selecting, extracting, transforming, mixing, counting, splitting, etc., and other tasks in communication and cooperation with other elements, such as mapping logic 205, scoring and classification logic 211, algorithm support logic 213, and/or the like. Stated differently, this neuron operations logic 207 allows for smooth operation of the novel MP architecture as facilitated and supported by MP mechanism 110 and/or one or more of MP components 120, 130 of FIG. 1.

Further, although most of this document is discussed in light of these and other elements of MP mechanism 110, it is contemplated that one or more of MP components 120, 130 of FIG. 1 may also include one or more of the same elements as those of MP mechanism 110. However, for the sake of brevity, the discussion is limited to one or more elements of MP mechanism 110.

This novel MP architecture 300, as illustrated in FIG. 3A, is a layered architecture, where a flow of input-output messages long a path, or paths, from a first layers of neurons, such as selectors 301, up to a last layer of neurons, such as counters 310, ending in a learned class feature may be embedded in an algorithm as facilitated by MP mechanism 110. Such a flow may be regarded as a learned algorithm used for solving a given problem or performing a given task. Further, by mapping neuron paths and their associated input-output flows into learned algorithms, as facilitated by mapping logic 205, this novel MP architecture 300 succeeds in supporting more flexible training, while a certain confidence level associated with a classification result may be explained, as various processing neurons 301-311 along the path are used for providing concise interpretable data on why and how there are any detections.

In one embodiment, training in this novel MP architecture 300 is no longer a non-linear optimization process; rather, it is regarded as a genetic algorithm-based process. In this process, multiple genetic candidate algorithms, which are input-output flows along neuron paths, compete in order to solve a given ML problem or perform an assigned ML task. In this way, training becomes ‘survival of the fittest’ contest such that any success is measured by a number of occurrences of features measured among all training data and along the various paths of MP architecture 300. Such measurements are performed by the counters 311. This paradigm includes learning class features based on the number of occurrences of features among training data over a period of time.

In one embodiment, this novel MP architecture 300 further supports both supervised and unsupervised learnings. In general, supervised learning is a process by which a neural network architecture optimizes the parameters used by its neurons in order to perform a specific task. In MP architecture 300, some neuron functions may be found redundant as part of the training process, where MP architecture 300 essentially replaces gradient descent with a neuron elimination process, which is also associated with the survival of the most relevant features. This MP architecture 300 is also used to support unsupervised learning, where the presence of common and frequently encountered features may be regarded as an indication of a new object class and no labeling is required.

As previously described with reference to FIG. 1, in some embodiments, this MP architecture 300 can also be hardware-supported, such as having mass amounts of more generic compute operations performed multifunction perceptrons based on processing cores as supported by one or more of MP components 120, 130. Further, for example, any scoring or classification processes may be performed using scoring and classification logic 211 of FIG. 2 and/or through implementation of custom accelerators or FPGAs, etc., as part of one or more of MP components 120, 130. Stated differently, MP architecture 300 of FIG. 3A may be used to as a machine or an engine for generating customized algorithms for detecting and solving specific ML tasks in computing environments.

Multifunction Perception Implementation and Architectural Considerations

As illustrated with respect to FIGS. 3A-3B, neurons 301, 303, 305, 307, 309, 311 in MP architecture 300 may include software processes or threads running in a plurality of processors that can be homogeneous or heterogeneous as facilitated by neuron management logic 203 of MP mechanism 110. Alternatively, as described above, neurons 301-311 may be implemented as hardware threads or by means of sequential logic as part of custom application-specific integrated circuit (ASIC) architectures as facilitated by or through one or more of MP components 120, 130 of FIG. 1. Connectivity between neurons 301-311 may be realized by a plurality of interconnects or buses, connecting the processors where such neurons 301-311 run.

For example, as illustrated with respect to FIG. 3B and as facilitated by mapping logic 205 of FIG. 2, mapping 350 includes logical graph 351 describing MP architecture 300 is mapped to physical graph 353 consisting of available processors and interconnects, where each logical link may be mapped to a physical link, where each neuron 301, 303, 305, 309, 311 may be mapped to a physical processor or custom ASIC. It is contemplated that processors, such as application processor 112, graphics processor 114, etc., may include processing cores of computing device 100 being represented as a client system or a server system (e.g., smart devices, laptops, desktops, cloud servers, etc.), low power cores, or tiny cores with sufficient computing resources to simply run the functions which these neurons 301-311 can support (e.g., edge detection, color detection).

For example, MP architecture 300 may run on a general-purpose server computer, consisting of eight sockets, each supporting 16 cores and 32 threads, and a memory hierarchy consisting of per core L1, per core L2, shared L3, and external double data rate (DDR) memory units, etc. Alternatively, MP architecture 300 may run on an array of tiny cores, consisting of 16K tiny cores, where each tiny core may support a limited instruction set to run any perceptron functions, a small local scratchpad memory (e.g., 128K bytes scratchpad) and a plurality of interconnects to communicate with other tiny cores.

As illustrated in FIG. 3B, this embodiment of mapping 350 between logical graph 351 and physical graph 353, as facilitated by mapping logic 203 of FIG. 2, describes MP architecture 300 with logical graph 351 is shown as including various neurons including four selectors S₁-S₄ 301, three feature extractors F₁-F₃ 303, two splitters L₁, L₂ 305, two mixers Mi, M₂ 307, and one counter C₁ 311. This logical graph 351 is mapped to physical graph 353, which is shown as having five processors p₁-p₅. This illustrated mapping 350 places selectors logical nodes S₁-S₄ 301 into physical mode pi. Similarly, extractors logical nodes F₁-F₃ 303 are placed into physical nodes p₁ and p₃, while splitters logical nodes L₁, L₂ 305 are placed into physical node p₄, and finally, mixers logical nodes M₁, M₂, 307 and counters logical node C₁ 11 are placed into the physical node p₅.

Referring back to FIG. 2, in one embodiment, neurons in this novel MP architecture are heterogeneous and capable of performing functions from a set of domain specific choices, where the overall cognition capability of the MP architecture is composed from these functions. These neurons of the MP architecture are regarded as extensions of a convolution primitive, which is used by the neurons of more conventional convolutional and deep neural network architectures. Such extensions are specific to a particular domain (e.g., image processing, audio processing. etc.). As will become evident in the description that follows, the convolution primitive of conventional DNNs is merely one of the primitives that are supported by the MP architecture.

The description that follows explains the the domain of image and video processing, and its purpose is to illustrate how this novel MP technique works in the context of one particular domain of interest. As described above with reference to FIGS. 3A-3B, neurons can be of the following types: selectors, extractors (e.g., edge feature extractors, color feature extractors, shape feature extractors, texture feature extractors, etc.), splitters, transformers (e.g., rigid transform neurons, non-rigid transform neurons, color correcting neurons, frequency domain transform neurons, principle component analysis (PCA) neurons, shape fitting neurons, etc.), mixers, and counters.

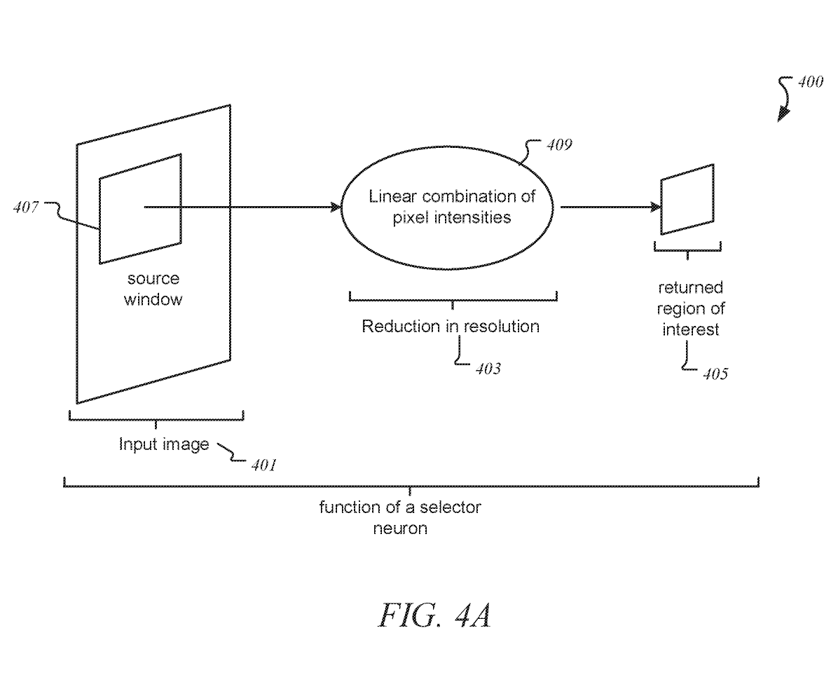

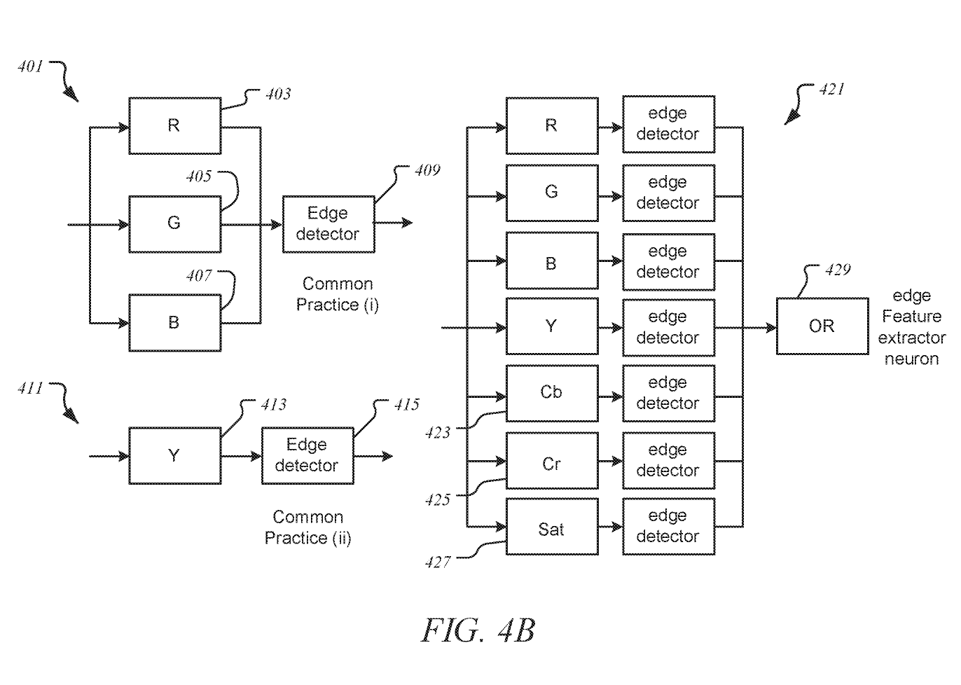

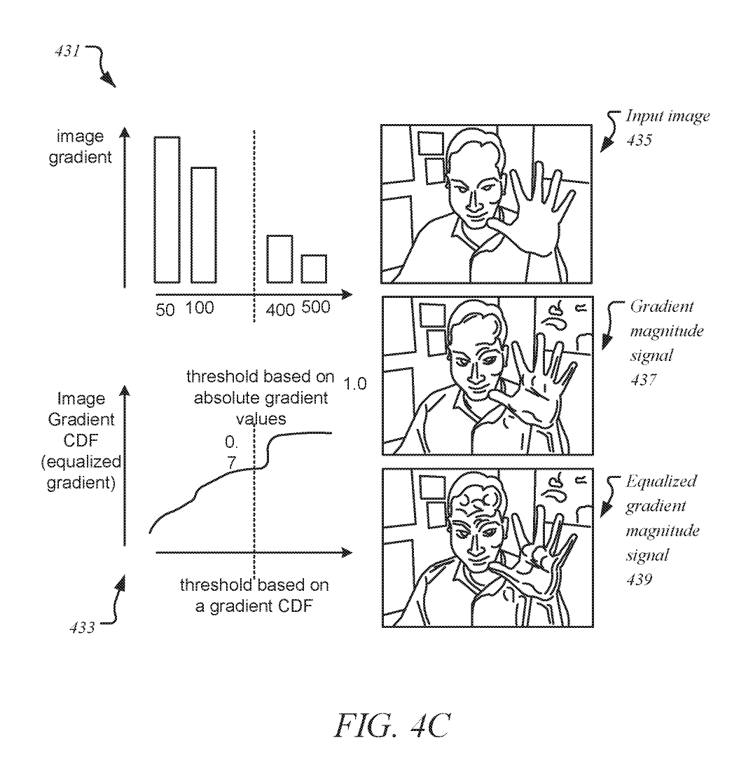

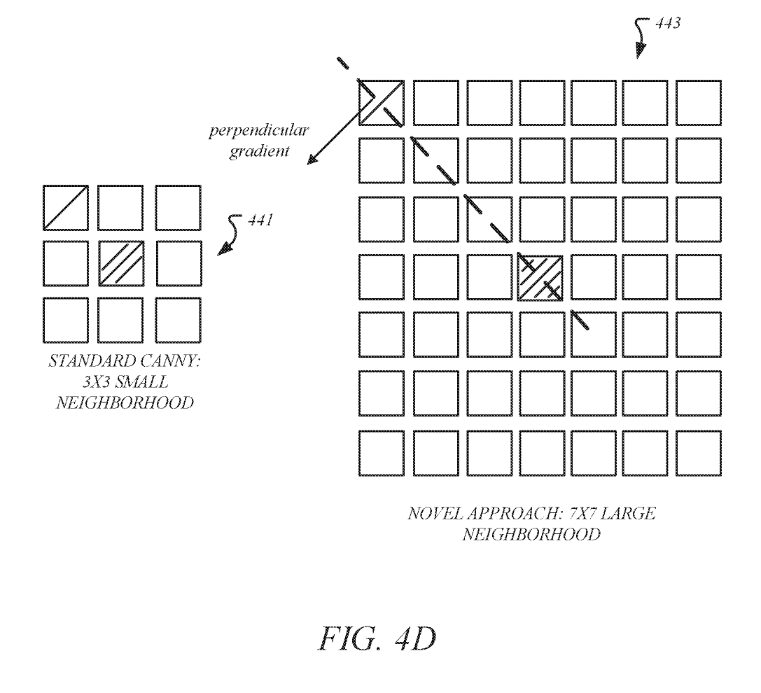

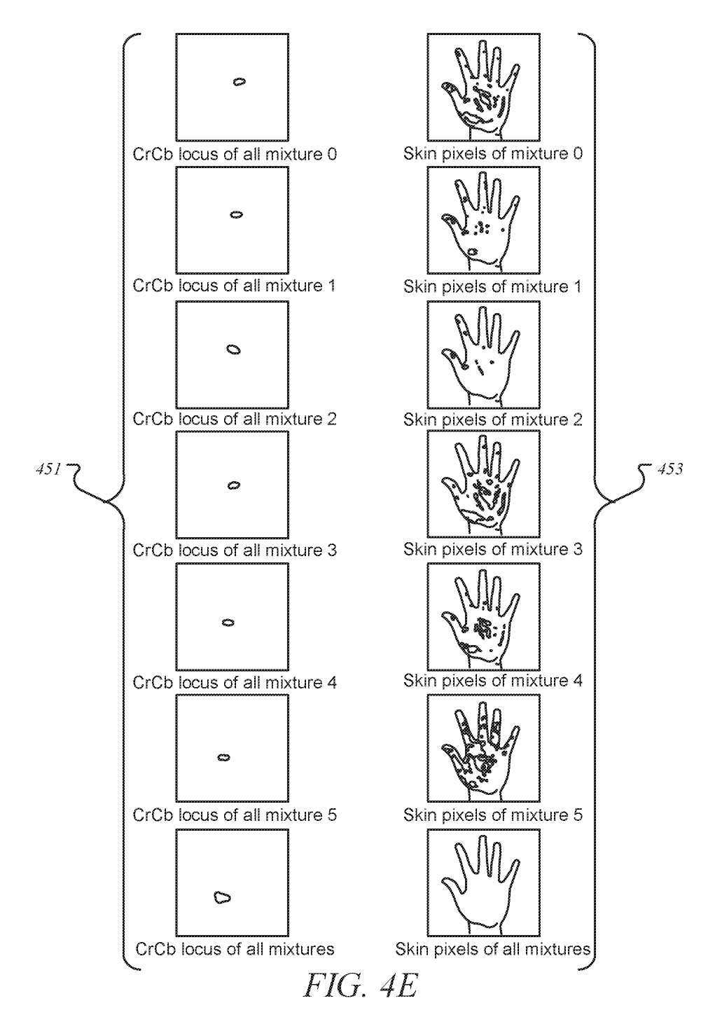

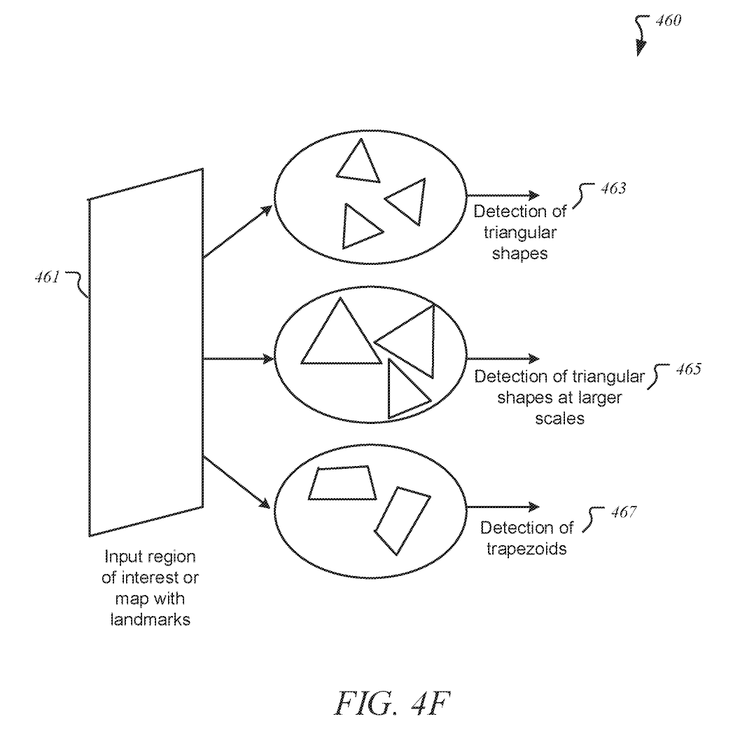

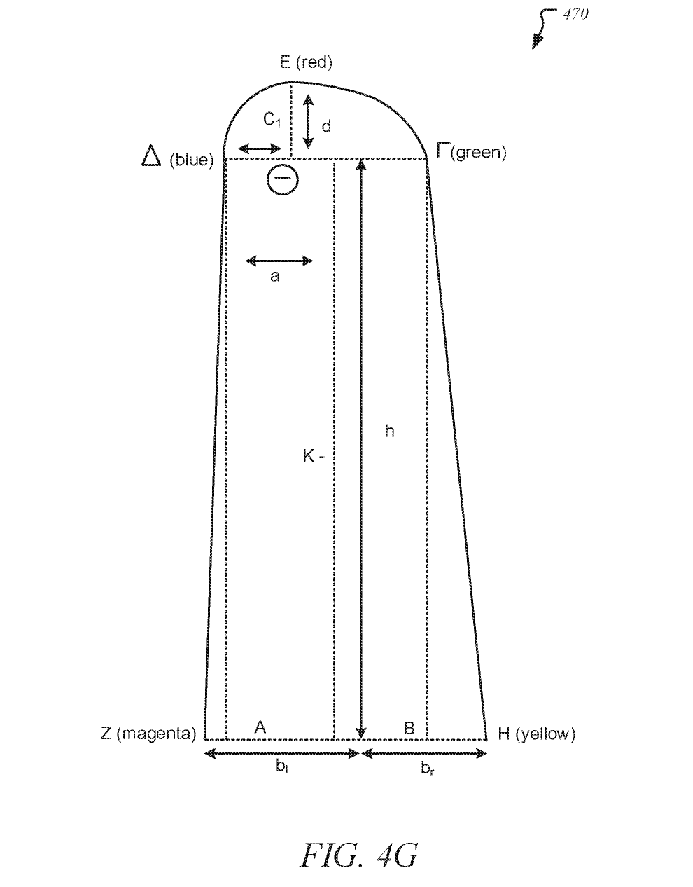

With regard to selectors, as facilitated by neurons operations logic 207, they can accept as input a two-dimensional (2D) signal (e.g., image, video frame, etc.) and return a specific region of interest from this image frame. In one embodiment, the returned region of interest may be a square of a rectangular one, where such selectors may be used to reduce or increase the resolution of the returned region of interest. For example, as illustrated in transaction sequence 400 of FIG. 4A, any reduction 403 may be accomplished by computing each pixel of the returned region of interest 405 as a linear combination of the intensities of the pixels 409 in a smaller rectangular region 407 of the input image 401 of frame.

Conversely, any increase in the resolution of the returned region of interest may be accomplished by running some known super-resolution algorithm, such as Bayesian induction, etc. Coming back to FIG. 4A, a selector neuron accepts as input a two dimensional signal X={x_{0,0}, x_{0,1}, . . . , x_{0,w-1}, . . . , x_{h-1, w-1}} of size hxw and produces in its output another two dimensional signal Y={y_{0,0}, . . . , y_{hf-1, wr-1}} of size h′×w′, where each pixel intensity in this output signal is computed as a linear combination of the pixel intensities of a smaller region of X:

$${y}_{I , J} = {\sum }_{i = - {h}_{I} \text{/} 2}^{{h}_{I} \text{/} 2} {\sum }_{j = - {w}_{J} \text{/} 2}^{{w}_{J} \text{/} 2} {s}_{i , j} \cdot {x}_{I + i , J + j}$$

Where h_{I} and w_{J} are the dimensions of the region from signal X, which is used for computing the pixel intensity, where y_{I,J} and s_{i,j} are scaling constants associated with the pixel position I, J and the reduction in resolution, which is achieved by the specific selector neuron. Several selector neurons may run in parallel each returning a different region of interest from the input signal X. Furthermore, selectors may be increasing or decreasing the resolution of their target regions using different scaling factors (e.g., decreasing by 2, deceasing by 4, etc.) of scaling constants (e.g., different s_{i,j} constants, etc.). In one embodiment, a pyramid representation of an image, from computer vision, may be realized through a collection of such collaborating selectors.

With regard to extractors, as facilitated by neurons operations logic 207, as previously described with reference to FIGS. 3A-3B, edge feature extractor neurons accept as input the regions of interest returned by the selectors, where edge feature extractor neurons perform specialized feature extraction tasks. In one embodiment, edge detection is considered not a monolithic but a parameterizable operation; for example, one way to make edge detection parameterizable is to realize it in one or more ways, such as the algorithm that performs edge detection may be operating not on a single 2-dimensional signal (e.g., gray scale) as typical edge detectors do, but on a plurality of 2-dimensional signals referred to as ‘channels’.

As illustrated in transaction sequences 401, 411, 421 of FIG. 4B, extractors or edge feature extractor neurons may run edge detection algorithms in order to detect the presence of edges in at least one of the following channels: (i) the red color component of the RGB representation (R) 403; (ii) the green color component of the RGB representation (G) 405; (iii) the blue color component of the RGB representation (B) 407; (iv) the Y-luminosity component of the YCbCr representation (Y) 413; (v) the chromatic blue component of the YCbCr representation (Cb) 423; (vi) the chromatic red component of the YCbCr representation (Cr) 425; and (vii) the saturation component of the HSV representation (S) 425. A pixel in a bitmap returned by each r, which may be the result of a logical OR operation, such as by OR 429, performed on the bitmaps computed by a plurality of edge detectors 409, 415 with each operating on one or more such channels.

In on embodiment, where each edge feature extractor neuron operates on a different subset of channels, such as those listed and illustrated in FIG. 4B, in one extreme case, an edge feature extractor neuron may be operating on a single channel only, where, in another extreme case, an edge feature extractor neuron may be operating on a complete set of channels available for edge computations. In one embodiment, another way to parameterize edge detection is to modify the way in which image gradients are computed, where edge detectors typically compute the magnitude and angle of image gradient signals in each pixel position of their 2-dimensional output. This is achieved by performing convolutions with some fixed second order Gaussian derivatives, such as Sobel operators. In one embodiment, this novel MP architecture departs from the typical implementations of edge detectors, based on the standard Canny algorithm, by not using fixed Sobel operators; rather, the implementation and operation of edge detectors is achieved by constructing and using parameterizable convolution boxes directly from the equations that define the second order Gaussian derivatives as follows:

$${ℊ}_{x} ( x , y ) = \frac{- x}{2 {πσ}^{4}} \cdot {e}^{- \frac{{x}^{2} + {y}^{2}}{2 {σ}^{2}}}$$

$${ℊ}_{y} ( x , y ) = \frac{- y}{2 {πσ}^{4}} \cdot {e}^{- \frac{{x}^{2} + {y}^{2}}{2 {σ}^{2}}}$$

Edge feature extractor neurons may differ in a way that they set the parameters of their convolution boxes. For example, edge feature extractor neurons may set the variance parameter σ to different values higher than 1. For some neurons, σ may be equal to 2, while for other neurons, 6 may be equal to 4, 8 r 16. Having neurons with different configurable convolution boxes operating in parallel helps with de-noising input frames more effectively, while it may also help with ignoring edge pixels associated with rough texture, which may not be useful to a particular application (e.g., texture irrelevant to the detection of some objects). Conventional DNN architectures typically employ a large number of trained convolutional neurons, optimized through gradient descent, but such manner lacks control.

In contrast, embodiments provide for this novel MP architecture that deploys a large number of heterogeneous edge detection neurons that are both configurable and also exhaust the space of all possible configurations. Training, using this novel MP architecture, includes a process of observing which neurons, from the many deployed, are the most useful in performing a specific recognition task. For these reasons, as further described below, the novel MP architecture is both explainable and controllable when compared to conventional DNNs.

Once gradient magnitude and angle values are computed, in one embodiment, extractors proceed with converting image gradients to edge bitmaps, where this is done by using multiple magnitude thresholds (e.g., two magnitude thresholds), such as a high threshold and a low threshold. Further, in the conventional Canny algorithm-based implementations, thresholds are defined empirically. In contrast, in this novel MP architecture, thresholds are configurable, while neurons do not apply the thresholds directly on image gradient values; rather, they are applied on histograms of gradient magnitude values.

For example, as illustrated in graphs 431, 433 FIG. 4C, neurons do not necessarily compute edges directly from gradient magnitude values; rather, they compute from gradient magnitudes that have undergone histogram equalization. Such computation results in more robust edge detection and can be done in each of the channels employed, such as R, G ,B, Y, Cb, Cr and S. In each channel, high and a low threshold values, such as H and L, may be defined by neurons as those values that separate the best H % and L % pixels from the rest of them, where best refers to pixels with the highest gradient magnitude values. For example, a neuron may set H=8 and L=35, while other neuron may set different threshold values.

This use of equalized image gradient signals by edge feature extractor neurons is illustrated in graphs 431, 433 of FIG. 4C, where graph 431 illustrates values between an image gradient versus a threshold based on absolute gradient values, while graph 433 illustrates an image gradient CDF (equalized gradient) versus a threshold based on a gradient CDF. FIG. 4C further illustrates input image 435, gradient magnitude signal 437, and equalized gradient magnitude signal 439.

Once the thresholds are defined, they are used in a manner similar to Canny, where, for example, low thresholds reference ‘thin’ edges that pass a second filtering stage where the pixels that remain are associated with local gradient magnitude maximum appearing along the gradient angle. From among these thin edges, pixels with gradient magnitude value higher than the high threshold are marked as ‘thick edges’ and loaded into a stack. From then on, edge detection algorithms remove pixels from the stack one-by-one and examine their neighbors. If, for example, a neighbor is thin edge in a thick edge neighborhood, then it is marked as thick edge and further added to the stack. This process stops when there are no more pixels to add, such as when the stack is empty.

In one embodiment, as illustrated with respect to FIG. 4D, this novel MP architecture is further distinguished over the conventional Canny structure, such as small 3×3 neighborhood 441, with regard to the definition of a neighbor q of a pixel p. For example, edge feature extractor neurons do not merely examine the 8 adjacent pixels to a pixel p, which is stored in the stack, but all pixels in a neighborhood of specific width and height around p, where the neighbor width and height are properties of a neuron. For example, some neurons may apply such hysteresis on 5×5 neighborhoods, while others may apply the hysteresis on 7×7 neighborhoods, such as large 7×7 neighborhood 443 of FIG. 4D. In addition, neurons do not mark a ‘thin’ edge q as ‘thick’ only if it is in the neighborhood, but also check that the slope of the line connecting p and q is perpendicular to the gradient at p or q. In this way, edge detector neurons potentially add more contour line pixels into the final bitmap, which otherwise would be dropped by the conventional Canny hysteresis as illustrated in FIG. 4D.

In one embodiment, as facilitated by neurons operations logic 207, color feature extractor neurons detect the presence of specific color properties in various regions of interest passed to them as inputs. Like edge feature extractor neurons, color feature extractor neurons are also parameterizable and configurable. Color feature extractor neurons may be parameterized with respect to the color channels they accept as their input, the number of major color components they maintain as state, the manner in which major color components are described and the specific sub-regions of luminance of chrominance where neurons perform detections.

For example, the color feature extractor neurons may be used to compute color distributions that can successfully predict the chrominance properties of a target object class; moreover, such computations should allow for rapid changes in luminance In one embodiment color feature extractor neurons employ lightness-invariant color models, where lightness-invariant color models are defined in color spaces that separate the chrominance from the luminance components. Examples include (but not limited to) the ‘Hue-Saturation-Value’ (HSV) color space, the ‘Y luminance-Chromatic red-Chromatic blue’ (YCrCb) space, etc. For example, HSV allows a value (V) component to be excluded from a color description and similarly, YCrCb allows a Y luminance component to be excluded from a color description. Further, multiple color feature extractor neurons may run in parallel, while each operating on a different color space.

In one embodiment, as facilitated by neurons operations logic 207 and algorithm support logic 213, color model computations are performed by neurons using one or more algorithms or techniques, such as Expectation Maximization (EM) algorithm. In other embodiments, or in other neurons of the same embodiment, alternative methods such as on-line k-means clustering or hybrid on-line/standard k-means clustering may be used. In this document, an overview of expectation maximization is provided, while an initialization routine is defined, which increases the speed of convergence of the algorithm.

For example, EM models a probability density function as a linear combination of Gaussian functions referred to as Gaussian mixtures. Such a model is called a Gaussian Mixture Model (GMM), where for a set of input values (seeds), EM computes mixture parameters that result in a density function which maximizes the likelihood of these seed values. Seed pixels, for example, refer to those pixels that are contained in the regions of interest returned by the selectors. The probability density function used by the EM algorithm is as follows:

$$Pr ( \tilde{x} ; θ ) = {\sum }_{i = 1}^{G} \frac{{c}_{i}}{\sqrt{{( 2 π )}^{d} \cdot \vert {Σ}_{i} \vert}} \cdot {e}^{- \frac{{( \tilde{x} - {\tilde{μ}}_{i} )}^{T} \cdot {( {Σ}_{i} )}^{- 1} \cdot ( \tilde{x} - {\tilde{μ}}_{i} )}{2}}$$

Where \tilde{z} is an input vector of dimensionality, d and θ are the Gaussian mixture model used by the algorithm, such as using the Hue-Saturation (HS) or Chromatic red-Chromatic blue (CrCb) color spaces d=2. The Gaussian mixture model θ further comprises a number of Gaussian mixtures G, where the i-th Gaussian mixture is associated with a GMM coefficient cᵢ, a mean value vector \tilde{μ}ᵢ, and a covariance matrix Σᵢ. The GMM coefficients cᵢ, the mean value vectors \tilde{μ}ᵢ, and the covariance matrices Σᵢ for 1≤i≤G, are the parameters of the model θ.

For example, as facilitated by algorithm support logic 213, the EM algorithm may make some initial guesses for the parameters of the Gaussian mixture model, where, for example, the speed of convergence of EM depends on how the accuracy of the initial guess. Once an initial guess is made, the EM algorithm updates the parameters of the model considering seed values \tilde{x}₁, \tilde{x}₂, . . . , \tilde{x}ₙ, where, first, the i-th GMM coefficient is updated to a value êᵢ, which is the probability that the event characterized by the density of the above-mentioned equation, and is true due to the i-th mixture being true. This probability is averaged across seed values \tilde{x}₁, \tilde{x}₂, . . . , \tilde{x}ₙ as follows:

$${\hat{c}}_{i} = \frac{1}{n} \cdot {\sum }_{j = 1}^{n} {\hat{c}}_{ij} , {\hat{c}}_{ij} = \frac{\frac{{c}_{i}}{\sqrt{{( 2 π )}^{d} \cdot \vert {Σ}_{i} \vert}} \cdot {e}^{- \frac{{( \tilde{x} - {\tilde{μ}}_{i} )}^{T} \cdot {( {Σ}_{i} )}^{- 1} \cdot ( \tilde{x} - {\tilde{μ}}_{i} )}{2}}}{Pr ( {\tilde{x}}_{j} ; θ )}$$

Second, the mean value vector of the i-th mixture is updated to a value \tilde{\hat{μ}}ᵢ which is equal to the mean output value of a system characterized by the density of Pr(\tilde{z}; θ) (as shown in the equation above) where only the i-th mixture is true. The mean value is taken across seed values in, in, . . . as follows:

$${\hat{\tilde{μ}}}_{i} = \frac{{\sum }_{j = 1}^{n} {\hat{c}}_{ij} \cdot {\tilde{x}}_{j}}{{\sum }_{j = 1}^{n} {\hat{c}}_{ij}}$$

Finally, the covariance matrix of the i-th mixture is updated to a value \hat{Σ}ᵢ, which is equal to the mean covariance matrix of the output of a system characterized by the density of Pr(\tilde{x}; θ), where only the i-th mixture is true. The covariance matrix is computed as an average across seed values \tilde{z}₁, \tilde{z}₂, . . . , \tilde{x}ₙ as follows:

$${\hat{Σ}}_{i} = \frac{{\sum }_{j = 1}^{n} {\hat{c}}_{ij} \cdot ( {\tilde{x}}_{j} - {\tilde{μ}}_{i} ) \cdot {( {\tilde{x}}_{j} - {\tilde{μ}}_{i} )}^{T}}{{\sum }_{j = 1}^{n} {\hat{c}}_{ij}}$$

Now, in one embodiment, to speed up the convergence of EM neurons use a following heuristic algorithm for initialization. Specifically, neurons may define initial EM mean value vectors and covariance matrices from mean and standard deviation parameters of the seed values passed as inputs to these neurons. This is because any statistical properties of the seed values are regarded as the best values to indicate which model parameters are good guesses for the initialization of EM.

First, the neurons are set to the number of mixtures to a value n=q^{d} for some odd number q. In one embodiment, q=3 and d=2 and hence, n=9 mixtures. The number q reflects how many values from each dimension are selected in order to construct the initial mean value vectors of the model θ, while GMM coefficients are all initialized to 1/n. The initial mean value vectors of θ are constructed from average values μⱼ^{(d)}, while the standard deviation values σⱼ^{(d)}, 1≤j≤d, are computed from the seed values across the d dimensions. Let p, Δσⱼ and μ_{j,k}^{(d)} be defined by the following equation for some indexes j and k:

$$p = ⌊ \frac{q}{2} ⌋ , {Δσ}_{j} = \frac{{σ}_{j}^{( d )}}{p} , {μ}_{j , k}^{( d )} = {μ}_{j}^{( d )} + k \cdot {Δσ}_{j} where 1 \leq j \leq d , - p \leq k \leq p$$

The initial mean value vectors of θ are those vectors that take all possible combinations of values μ_{j,k}^{(d)} in each of the dimensions indexed by j, where index k ranges between −p and p as in (7). Since index k can take q different values there are at most q^{d} mean value vectors which are as many as the mixtures as follows:

$${\tilde{μ}}_{1} = [ {μ}_{1 , - p}^{( d )} \text{:} {μ}_{2 , - p}^{( d )} \text{:} … \text{:} {μ}_{d , - p}^{( d )} ] , \\ {\tilde{μ}}_{2} = [ {μ}_{1 , - p + 1}^{( d )} \text{:} {μ}_{2 , - p}^{( d )} \text{:} … \text{:} {μ}_{d , - p}^{( d )} ] , \\ … , \\ {\tilde{μ}}_{d} = [ {μ}_{1 , p}^{( d )} \text{:} {μ}_{2 , p}^{( d )} \text{:} … \text{:} {μ}_{d , p}^{( d )} ]$$

An interpretation of the equations above with regard to

$$p = ⌊ \frac{q}{2} ⌋ , {Δσ}_{j} = \frac{{σ}_{j}^{( d )}}{p} ,$$

μ_{j,k}^{(d)} and \tilde{μ}_{1,3,d} is that the initial mean value vectors of model θ are defined from equally spaced values centered on the mean values computed in each dimension and differing from the mean values at most of the standard deviations of each dimension. In some embodiments, the maximum difference may be the standard deviation of each dimension times a scaling factor.

The covariance matrix Σᵢ of the i-th mixture of θ is similarly initialized from the standard deviation values of each dimension as follows:

$${Σ}_{i} = ( \begin{matrix}\begin{matrix}\frac{2}{{Δσ}_{1}^{2}} 0 \\ 0 \frac{2}{{Δσ}_{2}^{2}}\end{matrix} & ⋯ & \begin{matrix}0 \\ 0\end{matrix} \\ ⋮ & ⋱ & ⋮ \\ 0 \; 0 & ⋯ & \frac{2}{{Δσ}_{d}^{2}}\end{matrix} )$$

In some embodiments, as facilitated by algorithm support logic 213, an alternative technique or algorithm that can be used in place of EM is on-line k-means clustering. On-line k-means clustering trades off accuracy for efficiency, while defining Gaussian distributions using simpler clustering operations on the seed values. For each seed value, a decision is made as to whether the seed is part of an existing value cluster and such decision is based on the distance between a seed and a cluster center. If a seed is part of a cluster, the seed is added to the cluster and the cluster center and the standard deviation are updated using a low pass filtering mechanism as follows:

\tilde{\hat{μ}}ᵢ(1−ρ)·\tilde{μ}ᵢ+ρ·\tilde{x}ⱼ,

\hat{σ}ᵢ=(1−ρ)·σᵢ+ρ·(\tilde{x}ⱼ−\tilde{μ}ᵢ)^{T}(\tilde{x}ⱼ=\tilde{μ}ᵢ)

Where \tilde{x}ⱼ is an input seed value and ρ is a low pass filtering parameter, which is also a configurable property of neurons, where if a seed is not part of a cluster, a new cluster is created having the seed in its center and standard deviation set to a fixed value. The resulting clusters computed from the above formulae for \tilde{\hat{μ}}ᵢ and \hat{σ}ᵢ and the seed values determine the Gaussian mixtures of the final model. The resulting mixtures are as many as the clusters To determine if a seed is part of a cluster, a threshold distance, T, may be used as a configurable neuron property, where the mean value vectors of the mixtures are the cluster centers and the covariance matrices of the mixtures are determined from the standard deviation parameters of the clusters.

The above formulae for \tilde{\hat{μ}}ᵢ and \hat{σ}ᵢ do not require storing the seed values associated with each cluster and therefore, also the term ‘on-line k-means’. It is contemplated that certain more computationally expensive neurons may employ a variant of this algorithm where the seed values of each cluster are stored, in which case, the centers of the clusters can be more accurately computed as the centroids of the stored values of clusters. These include any seed values that are being added each time; moreover, a principal component analysis on the elements of the resulting clusters can be used for achieving better determination of covariance matrices of the mixtures as compared to using the above formulae for \tilde{\hat{μ}}ᵢ and \hat{σ}ᵢ.

As mentioned above, as facilitated by neurons operations logic 207, some color feature extractor neurons may use color spaces that exclude the luminance component from the description of colors, such as the two-dimensional CrCb and HS spaces. The two-dimensional spaces, like CrCb and HS, can act as color hash functions mapping much larger color spaces of 256³=16,777,216 values to the sets of significantly smaller number of colors (i.e., 256²=65536 colors), where the use of such mappings introduces color collisions between foreground and the background color surfaces, which may be significant.

In this novel MP architecture, as facilitated by MP mechanism 110 and/or one or more of MP components 120, 130, collisions are avoided by having multiple color feature extractor neurons operating in parallel, each being associated with a different color space, different set of mixture model parameters, and potentially different algorithms to produce those mixture models. For example, an algorithm learned by this novel MP architecture may be used to filter an object using many different neurons, where each neuron may use a different luminance-invariant color space, mixture model and algorithm. Any color spaces used by the MP architecture may be independent of each other, such as CrCb and HS. Here, the term “independent” refers to the knowledge of a color representation being in one space that cannot result in the knowledge of the representation of the same color in another space. In each neuron, pixels may be classified as relevant foreground pixels or irrelevant background pixels in varying manners, and if it is learned, as part of the training process, that some classifications are essential to a specific task (e.g., detection of a specific object), then a pixel may be classified as part of a target class, such as if it passes the relevant classifications. In this manner, collisions are avoided. This novel training process is further discussed in this document.

To further ease computations, in one embodiment, color feature extractor neurons may be used to approximate the locus of a particular color model with the union of any ellipse regions coming from the Gaussian mixtures of the model. Using ellipse regions for representing Gaussian mixtures is used because the locus of all points that have probability higher than a threshold is the interior of an ellipse if probability density is characterized by a single Gaussian function. Further, checking if a point is inside the interior of an ellipse is computationally simple as it involves merely a small number of operations involving multiplications, additions, and subtractions. Such operations are suitable for hardware acceleration, where the principle to skin color modeling is shown in FIG. 4E illustrating CrCb locus mixtures 451 to the left and skin pixel mixtures 453 on the right.

The use of ellipses assumes that the color space dimensionality is two-dimensional and if the color space dimensionality is higher than two, then the ellipsoids or other higher dimensional analogues of ellipses may be used. In the analysis that follows, assuming the use of two-dimensional color spaces, let the mean value vector of a mixture be \tilde{μ}=[μₓ: μ_{y}] and the elements of the inverse covariance matrix ½·Σ⁻¹ of a mixture be:

$$1 \text{/} 2 \cdot {Σ}^{- 1} = [ \begin{matrix}{α}_{00} & {α}_{01} \\ {α}_{01} & {α}_{11}\end{matrix} ]$$

From these values, compute the major and minor radii rₐ, r_{b} and the rotation φ of an ellipse region associated with the mixture and probability threshold T using the stages of the equations below, where the probability threshold T in one embodiment may be derived from the GMM coefficient associated with a mixture as follows:

$$C ← - ln ( T )$$

$${ϕ}_{1} ← arctan ( \frac{{a}_{11} - {a}_{00} + \sqrt{{( {a}_{11} - {a}_{00} )}^{2} + 4 {a}_{01}^{2}}}{2 {a}_{01}} )$$

$${ϕ}_{2} ← arctan ( \frac{{a}_{11} - {a}_{00} - \sqrt{{( {a}_{11} - {a}_{00} )}^{2} + 4 {a}_{01}^{2}}}{2 {a}_{01}} )$$

$${r}_{a 1} ← \sqrt{\frac{2 sin ( 2 {ϕ}_{1} ) \cdot C}{( {a}_{00} + {a}_{11} ) \cdot sin ( 2 {ϕ}_{1} ) + 2 {a}_{01}}}$$

$${r}_{a 2} ← \sqrt{\frac{2 sin ( 2 {ϕ}_{2} ) \cdot C}{( {a}_{00} + {a}_{11} ) \cdot sin ( 2 {ϕ}_{2} ) + 2 {a}_{01}}}$$

$${r}_{b 1} ← \sqrt{\frac{2 sin ( 2 {ϕ}_{1} ) \cdot C}{( {a}_{00} + {a}_{11} ) \cdot sin ( 2 {ϕ}_{1} ) - 2 {a}_{01}}}$$

$${r}_{b 2} ← \sqrt{\frac{2 sin ( 2 {ϕ}_{2} ) \cdot C}{( {a}_{00} + {a}_{11} ) \cdot sin ( 2 {ϕ}_{2} ) - 2 {a}_{01}}}$$

if r_{ba1}÷r_{b1} then φ←φ₁, r₁←rₐ₁, r_{b}←r_{b1}

else φ←φ₂, rₐ←rₐ₂, r_{b}←r_{b2}

A color vector \tilde{x}ⱼ=[x:y] may be determined that it is inside an ellipse region centered at [μₓ:μ_{y}], associated with radii rₐ, r_{b} and rotation φ using the stages of the last two equations above (r_{b1}, r_{b2}) and the first two equations (eₓ, e_{y}) below:

eₓ←(x−μₓ)·cos φ+(y−μ_{y})·sin φ

e_{y}←−(x−μₓ)·sin φ+(y−μ_{y})·cos φ

D←rₐ²·e_{y}²+r_{b}²·eₓ²−rₐ²·r_{b}²

If D≤0 then [x: y] is inside the ellipse; else, it is not.

In one embodiment, as facilitated by neurons operations logic 207, an alternative way to implement the color checks above is to build a lookup table for the color representations of each layer. For example, for two-dimensional spaces, the table size may be limited to 65,536 entries, where each entry contains a single bit indicating if a corresponding color representation is skin or not. This implementation technique is applicable not only to ellipse regions, but also to arbitrary color locations. One disadvantage of using lookup tables may be that lookup tables may become hotspots when accessed by multiple processing units in parallel. Further, some color feature extractor neurons may be using the above equations or lookup tables to also count the number of seed values passed as input that are inside their computed ellipse regions. Other neurons may perform the counting on fixed ellipse regions, where the ellipse region properties are assigned to neurons at configuration time.

Shape feature extractor neurons are used to detect the presence of specific shapes in their inputs as facilitated by neurons operations logic 207. For example, different neurons may detect the presence of different shapes, where shapes may be described as templates, where each template may result from concatenating line segments and curve segments (e.g., ellipse segments, circle segments), as illustrated in transaction sequence 460 of FIG. 4F. As illustrated in FIG. 4F, input region of interest or map with landmarks 461 is transacted into one or more of detection of triangular shapes 463, detection of larger scale triangular shapes 465, and detection of trapezoids 467, etc.

A template matching stage may place templates on top of distance maps or other maps containing landmarks, where distance maps, for example, may be computed from edge maps, where edge maps may be produced by edge feature extractor neurons. Templates may be placed at various locations in a map, where neurons calculate the cumulative distance between the edge pixels of the templates and the edge pixels of the map. Further, distance maps may be computed from edge maps using well known techniques, such as by using Voronoi diagrams.

Now referring to FIG. 4G, it illustrates an embodiment of a shape template, such as the illustrated finger template 470. This template 470 is shown as consisting of two line segments and two ellipse segments and is parameterized by six parameters as follows and illustrated: a, h, bₗ, bᵣ, cₗ and d. These parameters determine the line and ellipse segment end-points, where the parameters a, bₗ, bᵣ, cₗ and d can also be expressed in terms of their ratios over parameter h. Further, setting parameter h to a different value each time, one obtains different scaled versions of the same finger template. In this manner, parameters a, bₗ, bᵣ, cₗ and d indicate a finger template's shape whereas parameter h indicates its size.

A finger template can be rendered using its six parameter values as well as the location information. In general, for example, every template can be rendered using its line and curve segment parameters and location information. During rendering, neurons compute the coordinates of the pixels that constitute the drawn line and curve segments of the template, where a template may be rendered at various locations rotated by different angle values. The association of a template with location information, scale and/or size information and rotation information may be referenced as ‘template configuration’ in this MP architecture. Different neurons may operate in different subsets of the configuration space and to perform template matching, the coordinates of the pixels of a template configuration are used for obtaining information about the distances between these pixels and the edge pixels in an input edge map. This information comes from the corresponding distance map, where the metric, which may be used for determining the proximity of a template configuration to an actual contour in the input edge map, include the average squared distance of the pixels in a configuration and the closest edge pixels in the map.

Further, shape feature extractor neurons may employ multiple stages of template matching as facilitated by neurons operations logic 207. A first stage of template matching, for instance, may be a ‘coarse’ search for candidate template configurations, where during this stage a single shape may be used. Furthermore, during the coarse search the image width and height may be divided into intervals of a fixed number of pixels such as 8 pixels. Similarly, the scale space may be divided into intervals of 8 pixels. Last, the space of rotation values may also be divided into intervals of a fixed number of radians such as 0.19 radians. Other neurons may divide the search space into different sets of intervals, where each combination of location, scale and angle values coming from the aforementioned intervals is considered as a candidate template configuration. The configurations which pass onto the next stage are those which edge pixel distance is below a threshold.

A second stage of template matching employed by neurons may include a ‘refined search’ where the configurations that pass the coarse search undergo a series of scale, angle and location refinement operations. In this stage a single parameter value may be refined each time (i.e., scale, angle, location x or location y value), where this refinement may start by taking a parameter value, such as scale=s₀ and considering this value together with two additional values being apart by some quantity equal to half the interval used by the previous stage. Now, let the scale interval used in a previous stage be Δs, then the he two additional values considered are s₀+Δs/2 and s₀−Δs/2. The refinement operation may replace the value which is being refined by the one that results in the best edge pixel distance from among s₀, s₀+Δs/2 and s₀−Δs/2, where such refined search may involve two or more cycles. Each cycle may involve four separate refinement operations, such as scale, angle, location x, and location y refinement. Each cycle may use intervals which are half the values of the intervals used by the previous cycle, where a second pruning of configurations may then take place, using a threshold which is tighter than the threshold used in the previous stage.

Finally, a third stage of template matching may include a ‘shape refinement’ operation. In the previous stages, each configuration is associated with the same shape parameters as facilitated by neurons operations logic 207. For example, the same set of a, bₗ, bᵣ, cₗ and d values of a finger template. In this stage the shape of each configuration is considered against alternative shapes. Alternative shapes may be similar to the ones used before, albeit different, and are employed to further refine the template search process. At the end of this stage, a third pruning of template configurations takes place, using an even tighter threshold. In one embodiment, this last pruning uses an absolute (e.g., scale-invariant) threshold. The resulting configurations are the features returned by shape feature extractor neurons. Apart from template matching, shape feature extractor neurons may also be performing simpler tasks such as counting the number of times specific cuts, such as edge cuts, intersect with the edges or landmarks of some inputs.

In one embodiment, as facilitated by neurons operations logic 207, texture feature extractor neurons may be used for detecting the presence of specific texture components into their inputs where texture components may be detected through, for example, computing Local Binary Patterns (LBP), Difference of Gaussians (DoG) of Histograms of Gradients (HoG), or other equivalent algorithms in specific sub-regions of neuron inputs. As with the other types of feature extractor neurons, these neurons may also be configurable. For example, for the local binary pattern algorithm, configurability may be applied on the neighborhood size over which binary patterns are computed, the number of value ranges which are resent in a resulting histogram, and the types of relationship between pixels which are considered to be part of the pattern. For example, one type relationship considered may be that a central pixel intensity should always be higher than its neighbors. Another type of relationship may be that a central pixel intensity and the intensity of any neighbor should always be inside as specific range, etc.

Splitter neurons accept as input a feature vector, which may be returned by a feature extractor neuron, split this vector into subsets of elements, and pass at least one of the subsets onto their outputs as facilitated by neurons operations logic 207. Different splitter neurons pass different subsets onto their outputs, where the reason why such neurons may be used in this novel MP architecture is because any salient features characterizing an object class may be present in only a subset of the feature elements returned by a feature extractor neuron. Since it would be difficult to know which returned feature elements are essential and which not, splitter neurons divide the feature vectors, which are extracted at previous layers, into subsets and pass the subsets onto their outputs, where in at least one of the outputs salient features are isolated.

Features returned by feature extractor neurons, whether edge, color, shape or texture features usually have the form of vectors. For example, edge vectors may consist of lists of coordinates of edge pixels. Similarly, color vectors may consist of lists of Gaussian Mixture Model components characterizing color descriptors or lists of ellipse regions characterizing color loci. More formally, a splitter neuron accepts as input a feature vector X consisting of n elements X={X₀, X₁, . . . , Xₙ₋₁} and outputs at least one vector Y consisting of k elements, where k≤n and Y={Xᵢ_{₀}, Xᵢ_{ᵢ}, . . . , Xᵢ_{_{k−1}}} for some indexes i₀, i₁, . . . , iₖ₋₁∈ [0, n−1].

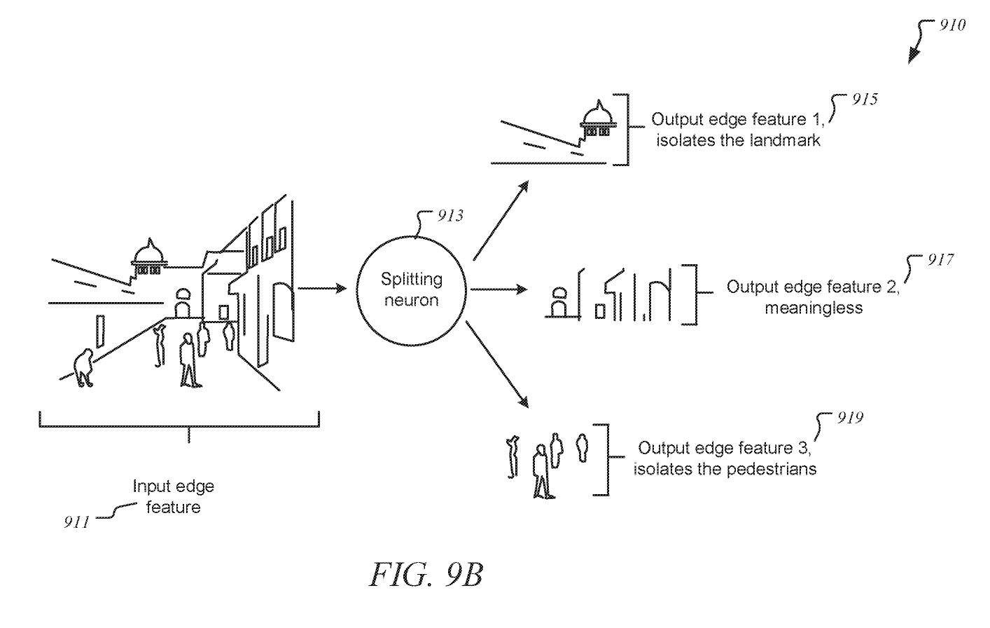

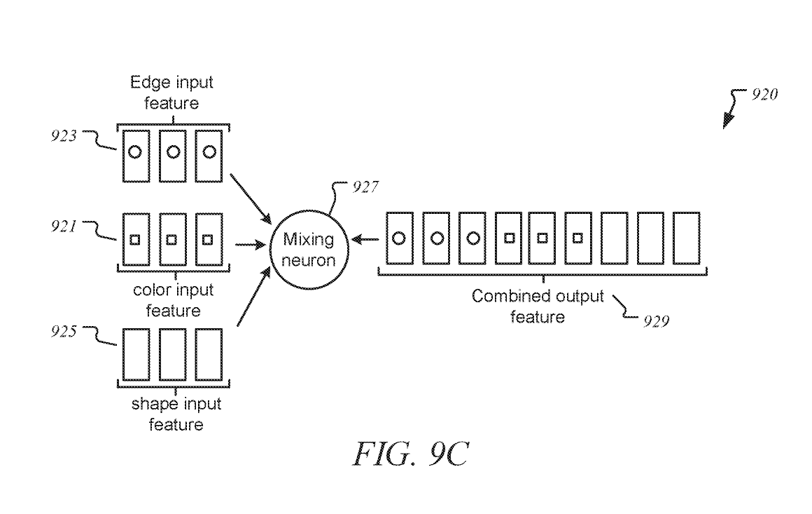

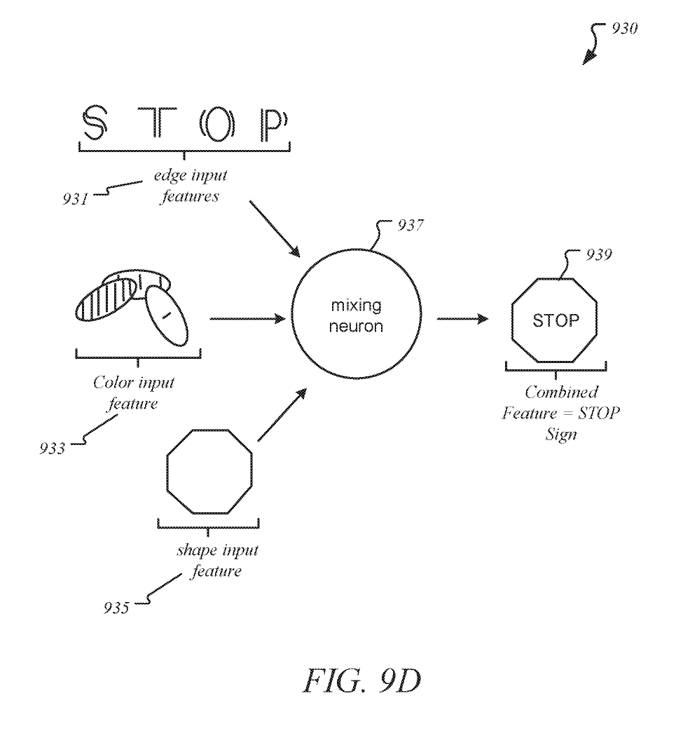

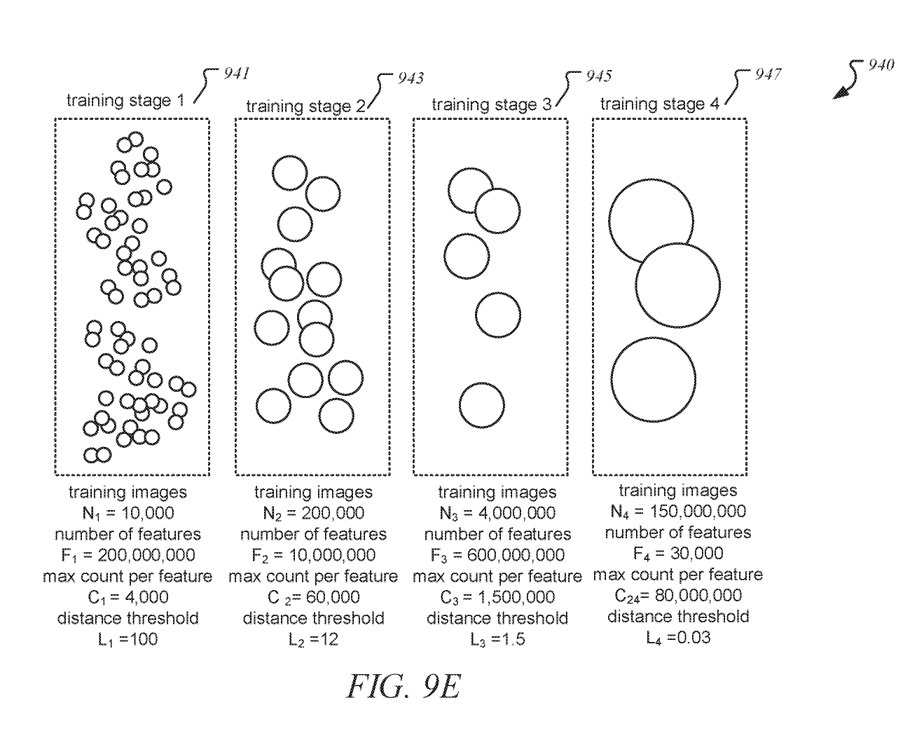

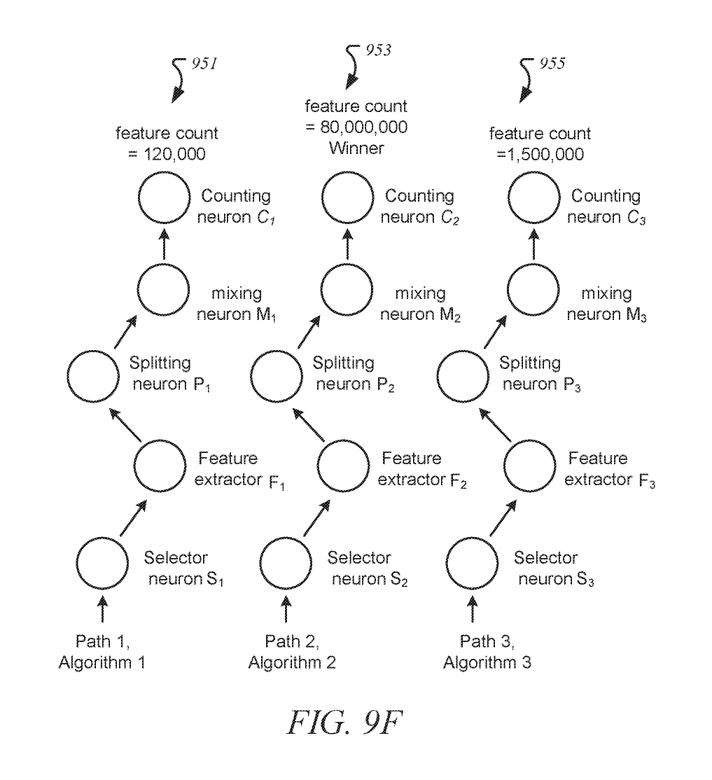

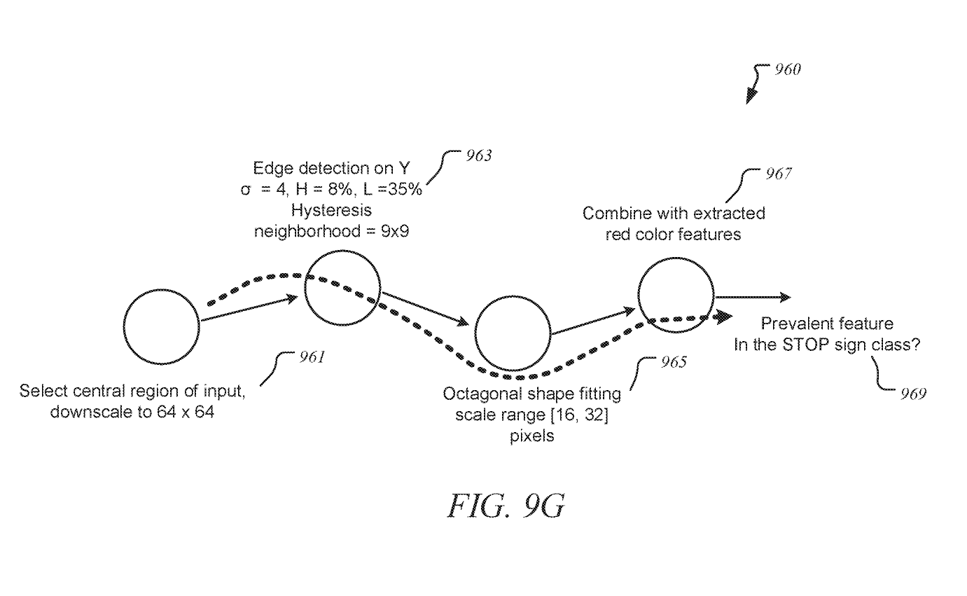

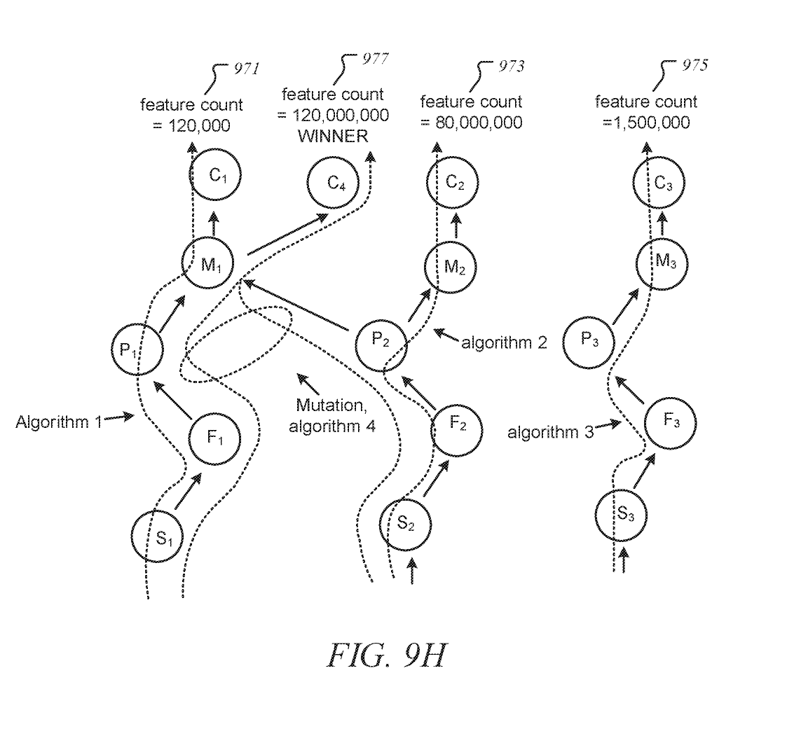

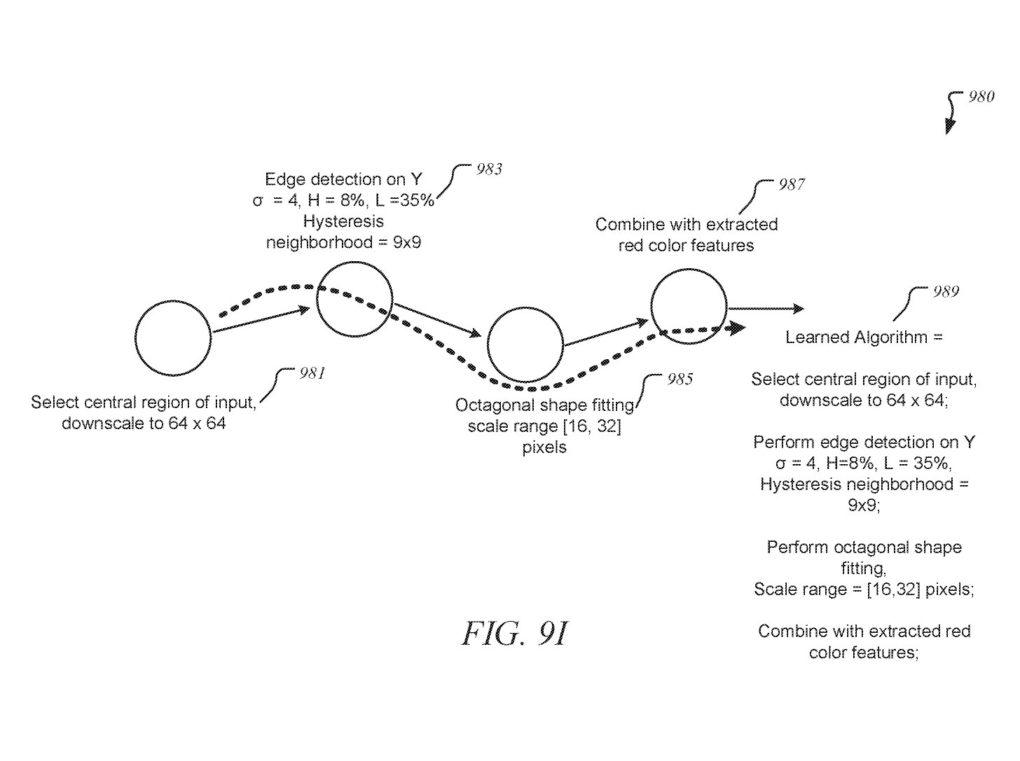

Referring to transaction sequence 900 of FIG. 9A, as facilitated by neurons operations logic 207, splitter neuron 903 is shown as accepting as input 901 a feature vector consisting of multiple elements, such as eight elements. Splitter neuron 903 then outputs three feature vectors 905, 907, 909, each consisting of three elements of the input vector. These feature vectors 905, 907, 909 are passed into three different subsequent neurons, where the first of the three, such as output feature 1 905, includes the first element, the third element, and the fourth element of the input vector of input 901, where elements are shown as feature elements kept, while the absent elements are shown as feature elements removed. Similarly, output feature 2 907 is shown as keeping and including the second element, the fifth element, and the sixth element of the input vector of input 901. Finally, output feature 3 909 is shown as having and keeping the first element, the seventh element, and the eighth element of the input vector of input 901. For fixed values of n and k, there can be at most

$$( \begin{matrix}n \\ k\end{matrix} )$$

output feature vectors, where these may be produced by at most

$$( \begin{matrix}n \\ k\end{matrix} )$$

splitter neurons. This novel MP architecture may employ splitter neurons that operate on all possible values of k from k=1 up to k=n; alternatively, splitter neurons may operate on a subset of the values of k from k=1 up to k=n. In an extreme case where k=1 splitter neurons output a single feature vector element, and in the case where k=n splitter neurons passing their input onto their output and no splitting takes place.

FIG. 9B illustrates transaction sequence 910 to show how splitter neuron 913 may isolate salient feature elements from input edge feature vector 911, where this input edge feature vector 911 is shown as including the contour lines of a landmark, a set of pedestrians, and surrounding walls. In one embodiment, splitter neuron 913 is shown as successfully isolating the landmark of input 911 into in feature vector 1 915 of the output, where feature vector 2 917 does not contain any meaningful content or salient features, and finally, feature vector 3 919 in contains the contour lines of the pedestrians.

Transform neurons perform certain transformations on feature vectors that are passed onto them by splitter neurons, as facilitated by neurons operations logic 207. Such transformations may include rigid transforms such as translation and rotation, non-rigid transforms such as warping, conversion to the frequency domain (such as using the discrete cosine transform), selection of the most dominant frequency components, principal component analysis, color correction, histogram equalization, histogram specification and luminance enhancement. Each type of feature vector, passed as input to transform neurons, may be suitable to only some of the types of transformations listed above. For example, color feature vectors may not benefit from transformations such as translation or rotation, whereas color correction transforms may be quite suitable for the color features of an object class. In general, a transform neuron accepts as input a feature vector X={X₀, X₁, . . . , Xₙ₋₁} of dimensionality n, and outputs a different feature vector Y={Y₀, Y₁, . . . , Yₘ₋₁} of potentially different dimensionality m, m≠n where Y=F (X) and the function F is equal to, without being limited to, one of the transforms listed above.

Mixer neurons create composite features from more fundamental features passed onto them from transform neurons, where the features passed as inputs to mixer neurons may be of varying types, as facilitated by neurons operations logic 207. Further, as described with reference to transaction sequence 920 of FIG. 9C, such features can be, for instance, edge features 923, color features 921, shape features 925, etc., being inputted into for processing by mixer neuron 927, resulting in combined output feature 929. Mixer neurons are used to combine such features together, such as into combined output feature 929, in order to create composite features that are more meaningful to the learning and classification processes and better describe the salient properties of a class.

For example, as illustrated with respect to transaction sequence 930 of FIG. 9D, for the detection of inputs like stop sign 931, color input 933, and octagonal shape feature 935, may be inputted into to be worked on by mixer neuron 937 to combine with edge features containing the contours of the letters S, T, O and P 931 and with GMM red color-related CMM components 933 and octagonal shape 935 into the output of STOP sign 939. The resulting composite output feature 939 is much more descriptive of the stop sign class as illustrated in FIG. 9D.

Referring back to FIG. 9C, mixer neuron 927 accepts as input three feature vectors 921, 923, 925, each consisting of three feature elements (shown as little rectangles), resulting in combined output feature 929 having combined all nine feature elements. This function performed by mixer neuron 927 may be regarded as a concatenation operation, where feature vectors 921, 923, 925 are combined by mixer neurons using more complex mixing operations that may include (but not limited to) scalar or vector additions, scalar multiplications, inner products, cross products, distance computations, logical operations, such as AND, OR, XOR, etc. Moreover, several mixer neurons may operate in parallel, each performing a different type of mixing operation, wherein mixer neuron 927 accepts as input feature vectors X₁, X₂, . . . , Xₙ and outputs a feature vector Y=M(X₁, X₂, . . . , Xₙ) that results by applying the mixing function M on X₁, X₂, . . . , Xₙ.

Similarly, referring back to FIG. 9D, it offers an embodiment of how mixer neuron 937 operates. Here, mixer neuron 937 accepts as input edge contour lines corresponding to the letters of the word STOP 931, and the pertinent color 933, such as red color-related Gaussian Mixture Model components, and the octagonal shape feature 935. In one embodiment, mixer neuron 937 combines all these features 931, 933, 935 together throughout concatenation, where the resulting feature 939 is descriptive of a STOP sign class.

For example, “counting neurons” or “counter neurons” or simply “counters” determine how many times certain features returned by mixer neurons appear among training data, as facilitated by neurons operations logic 207. These counter neurons essentially perform the necessary counting operations to determine whether some features are to be considered as salient features of a class. Counter neurons involving an operation in that features that frequently appear among training data correspond to visual characteristics that are almost always found in the objects of a target class. Terms like “counter”, “counting neuron”, and “counter neuron” are used interchangeably throughout this document.

One consideration in implementation and deployment of counter neurons is how to determine that certain features appear more than once in training data. For example, feature vectors corresponding to practically the same feature may not be exactly the same in that they are expected to differ at least slightly. If counter neurons consider equality of feature vectors in a strict sense, such as equality of their feature elements one by one, counter neurons may have to store and update counters for an excessively large numbers of features. Furthermore, considering similar, albeit different, feature vectors as distinct for the purpose of counting, may further confuse the training process. This is because, the salient features of a class may be present in the state of counter neurons via multiple representatives with low counter values, and hence may be more difficult to identify

Using the novel MP architecture, this issue may be handled and resolved in one or more ways, such as by considering that counter neurons use a distance metric and a distance threshold to determine similarity of feature vectors. Let L(X, Y) be a distance metric between two feature vectors X and Y, which may be the Euclidian distance, the Manhattan distance, the L-infinity distance or a combination of all above distance metrics. A counter neuron may consider two feature vectors X and Y as the same for the purpose of counting, if L(X, Y)<Lᵢ where Lᵢ is a distance threshold related to the stage of the training process. A stage of the training process is determined by a number of training images that are considered.

Referring to FIG. 9E, its transaction sequence 940 illustrates an embodiment of features detected by counter neurons and their properties as facilitated by neurons operations logic 207, as some training process advances from training stage 1 941, training stage 2 943, training stage 3 945, and training stage 4 947. In this illustrated embodiment, features are represented as circles, where the radius of each circle reflects a value a feature counter has associated with each feature. For example, the larger the radius, the larger the value of a feature counter associated with the corresponding feature. FIG. 9E illustrates a training process having four stages 941, 943, 945, 947, where at the first stage, a relatively small number of training images, such as N₁=10,000, are considered, and the number of distinct features observed by counter neurons is F₁=200,000,000. This is regarded as relatively large in number, as in this early stage, without a clear indication of which features are the salient ones, characterizing a target class, and thus counter neurons are to remember a large number of counted features. Further, at this this early stage 941, the maximum counter value per feature is also small, such as C₁=4,000, while the counter neurons use a relatively large distance threshold L₁=100 to determine similarity between features. This is because counter neurons are to observe similarities between large numbers of input feature vectors, while keeping their observations succinct and meaningful.

In training stage 2 943, a larger number of training images N₂>N₁, N₂=200,000 are considered, while a number of distinct features observed by counter neurons is F₂=10,000,000, which is smaller than F₁. This is because, in this stage 2 943 of transaction sequence 940 of the training process, counter neurons can safely prune features with lower counter values, keeping only a certain number of features with higher counter values. The maximum counter value per feature is also higher, such as C₂=60,000. Moreover, counter neurons use a lower distance threshold L₂<L₁, L₂=12 to determine similarity between features. This is because counter neurons manage a significantly smaller number of feature vectors and can use a lower threshold to distinguish between features.

Decrease in the number of features maintained by counter neurons and increase in the maximum counter value maintained per feature, are also observed when transitioning from stage 2 943 of the training process to stage 3 945. In stage 3 945, an even larger number of training images, such as N₃>N₂, N₃=4,000,000, are taken into consideration, where the number of distinct features is observed by counter neurons is F₃=600,000. The number is even smaller, as in this advanced stage of the training process, counter neurons is even more aggressive in pruning features with lower counter values. The maximum counter value per feature is C₃=1,500,000, which is the highest noted thus far. Moreover, counter neurons use a lower distance threshold, such as L₃<L₂<L₁, L₃=1.5, to determine similarity between features, for the same reasons as in stage 2 943.

The last stage, stage 4 947, marks the completion of the training process as shown in transaction sequence 940. In stage 4 947, all training images N₄=150,000,000 are taken into consideration, where the number of distinct features observed by counter neurons is F₄=30,000. These are the salient features of a target object class such that the maximum counter value per feature is C₄=80,000,000. Moreover, counter neurons use an even lower distance threshold, such as L₄=0.03, to determine similarity between features.

In one embodiment, as facilitated by scoring and classification logic 211, classification process uses the detected salient features as follows: from the set of detected salient features F={F₀, F₁, . . . } found during the training process, subsets Sᵢ={Fᵢ_{₀}, Fᵢ_{₁}, . . . } are formed, where each subset Sᵢ is defined using a set of indexes {i₀, i₁, . . . }. These subsets are defined so that they cover the set of training data, where cover indicates each image of the training data being set to demonstrates all features, such as Fᵢ_{₀}, Fᵢ_{₁}, . . . , of at least one subset, Sᵢ. During the classification stage, an input image is considered to be containing an object of the target class, if the image demonstrates all salient features Fᵢ_{₀}, Fᵢ_{₁}, . . . of at least one subset, Sᵢ computed by the training process. To manage observed features, counter neurons may employ a plurality of known data structures and hardware units, including but not limited to, hash tables, content addressable memories, trees, and direct acyclic graphs.

It is contemplated that earning in a multifunction perceptron architecture is no longer a non-linear optimization process; rather, it is regarded as a genetic algorithm-based process. In the novel MP architecture, paths are used for interconnecting neurons of different layers, where these paths may merge or split. For example, two paths passing through two parallel texture feature extractor neurons may merge, where such merging may result in improving the detection of some salient texture feature. In this case, the merging of two such paths, such as occurring in a subsequent mixer neuron, may be equivalent to having two different texture extraction algorithms mutating in order to form a new, better algorithm to solve any given classification issues.

In this novel MP architecture, the paths used for passing information from one neuron to the next may not be simply algorithms; rather, they could be more specific genetic algorithms In the novel MP architecture, as facilitated by algorithm support logic 213, these genetic candidate algorithms, which are input-output flows along neuron paths, may compete to solve a given ML problem or perform an assigned ML task. In this matter, training becomes ‘survival of the fittest’ contest, where the success is measured by a number of occurrences of features measured among all training data and along the various paths of the novel MP architecture. Such measurements are performed by the counter neurons.

As illustrated in FIG. 9F, three paths 951, 953, 955 are shown, which correspond to three different contender algorithms for performing the same given ML task, as facilitated by algorithm support logic 213. As illustrated, the first algorithm associated with first path 951 results in a maximum feature count of 120,000, while the second algorithm associated with second path 953 results in a maximum feature count of 80,000,000. Finally, the third algorithm associated with third path 955 results in a maximum feature count of 1,500,000. In this illustrated embodiment, the winning algorithm is the second one for resulting in the maximum feature count.

In one embodiment, as facilitated by algorithm support logic 213, a contender algorithm in a multifunction perceptron architecture is a path defining a flow of information from a first layer of selector neurons to a final layer of counter neurons. When information is passed from one neuron to the next, this information may include information about extracted feature vectors along with other information about the identities of neurons in the path that produced these feature vectors, which may include without being limited to, information about neuron types, information about algorithms run by neurons and information about parameters configuring neurons, etc. Furthermore, a path in the novel MP architecture may include a union of a plurality of simple paths, where such composite path is described by a directed acyclic graph.

Referring to FIG. 9G, it illustrates transaction sequence 960 providing equivalence of a path interconnecting neurons 961, 963, 965, 967, 969 and a contender algorithm, as facilitated by algorithm support logic 213. For example, first neuron 961 in the path is a selector neuron, which selects a central region of interest from an image, and then downscales this region to a resolution of 64×64 pixels. Similarly, second neuron 963 in the path is an edge detector, which uses a second order Gaussian derivative parameter σ=4, high and low thresholds H=8% and L=35%, operating on the Y luminosity channel and applies a hysteresis process on a neighborhood of 9×9 pixels. Moving forward, third neuron 965 in the path is a shape feature extractor neuron performing octagonal shape fitting using the scale range of 16-32 pixels, while fourth neuron 967 in the path is a mixer neuron which combines the extracted shape feature with Gaussian Mixture Model-based color features coming from detectors that operate in the chrominance region of the red color. Finally, fifth neuron 969 in the path is a counter neuron, which detects the presence of salient features associated with the STOP sign class. If stacking together of the functionalities of neurons 961-969 forms a process for determining the presence of a salient feature of the STOP sign class and thus, this path may be equivalent to an algorithm.

As discussed above, in one embodiment, the novel MP architecture stages a competition between algorithms, where algorithms are allowed to mutate in order to improve their scores. For example, as illustrated in FIG. 9H, the various paths 971, 973, 975, 977 and algorithms may be the same as those illustrated in FIG. 9F; however, here, in FIG. 9H, flows from paths 1 971 and 2 973 merge in mixer neuron M₁, producing a combined feature through path 4 977. Further, the presence of such combined feature is observed and counted by counter neuron C₄, where neuron C₄ produces a count of 120,000,000. The merging of flows from paths 1 971 and 2 973 corresponds to a mutation operation giving birth to a fourth algorithm through path 4 977, which is the new winner of this competition of algorithms As illustrated, this is because the feature counter value corresponding to this new algorithm is 120,000,000 which is greater than the counter value associated with the previous winner of FIG. 9F.

As described with reference to the training processes of the novel MP architecture, they result in determining salient features characterizing an object class. Further, any paths describing the flows of information between neurons correspond to genetic algorithms, where the paths that end in counter neurons that return learned salient features correspond to algorithms which win a staged competition. Now, in one embodiment, the union of such paths, ending in salient features of an object class, may be regarded as a ‘leaned algorithm’, as illustrated in FIG. 9I. For example, transaction sequence 980 of FIG. 9I may seem similar to that of transaction sequence 960 of FIG. 9G; however, in FIG. 9I, the path of transaction sequence 980 indicates the winner of a competition for detecting the STOP sign class, or at least is included in a union of paths, which all together constitute the competition winner when considering the work of all neurons 981, 983, 985, 987, 989. Back propagating through this path allows the novel MP architecture to trace all processing stages of the path's corresponding algorithm and the work of neurons 981-989. In this matter, the novel MP architecture forms an interpretable and implementable procedure, where this procedure reflects a learned algorithm.

Once the training process has determined a learned algorithm, the classification/scoring process, as facilitated by classification and scoring logic 207, may not need to use the same layered architecture for performing classification. Since the training process returns an interpretable, explainable, and implementable algorithm, the classification/scoring process may just implement the learned algorithm and not the entire layered architecture. This may be performed using, for example custom accelerators or FPGAs as part of one or more of MP components 120, 130. Based on these considerations, this novel MP architecture may be viewed or regarded as a machine for generating custom or customized algorithms for solving specific issues, such as vision tasks, which are conventionally difficult to perform, time consuming, and prone to human errors.

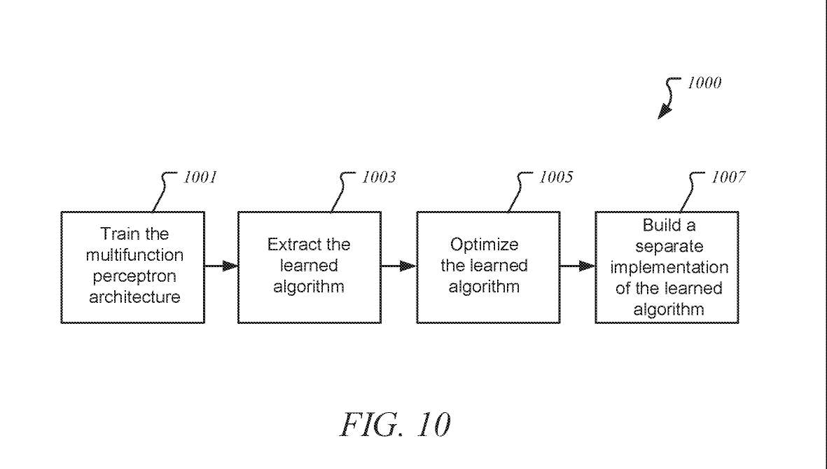

In one embodiment, as illustrated in method 1000 of FIG. 10, the implementation asymmetry between the training and classification/scoring stages is shown as building a functional artificial intelligence (AI) system using the novel MP architecture. First, at block 1001, training of the MP architecture is performed, such as to solve any issues like vision problems. At block 1003, the learned algorithm is extracted from the novel MP architecture, where, at block 1005, the parameters involved in the computations of the learned algorithm are optimized using various standard non-linear optimization techniques, such as back propagation and gradient descent, etc. Finally, at block 1007, a separate implementation of the optimized learned algorithm is being built.

Neurons in the novel MP architecture may include layers of neurons other than or in addition to those presented in this description, including any repeated layers or backward connections from layers that are further along in the processing pipeline to layers found in the pipeline. Further, learning using the MP architecture may be more predictable when compared to standard DNNs and more open to white box analysis and refinement. For example, a classification result may be accompanied by reasons, such as information relating to a detection and this is because such results may be produced by processing stages that are explainable and observable algorithms Such information can be concise, quantifiable and interpretable.

Moreover, as discussed earlier, in one embodiment, the novel MP architecture supports both supervised an unsupervised learning, where the supervised learning is a process by which a neural network architecture optimizes the parameters used by its neurons in order to perform a specific task. In this novel MP architecture, some neuron functions may be found redundant as part of the training process, where gradient descent is replaced with a neuron elimination process, which is also associated with the survival of the most relevant features. Such process may be more easily extended to unsupervised learning. In the case of unsupervised learning, the presence of a new set of common, frequently encountered features among a set of visual inputs is an indication of a new, previously unknown object class. In this way, learning is supported without any explicit labeling.

It is contemplated that embodiments are not limited to any number or type of microphone(s) 241, camera(s) 243, speaker(s) 243, display(s) 244, etc. For example, as facilitated by detection and monitoring logic 201, one or more of microphone(s) 241 may be used to detect speech or sound simultaneously from users, such as speakers. Similarly, as facilitated by detection and monitoring logic 201, one or more of camera(s) 242 may be used to capture images or videos of a geographic location (whether that be indoors or outdoors) and its associated contents (e.g., furniture, electronic devices, humans, animals, trees, mountains, etc.) and form a set of images or video streams.

Similarly, as illustrated, output component(s) 233 may include any number and type of speaker(s) or speaker device(s) 243 to serve as output devices for outputting or giving out audio from computing device 100 for any number or type of reasons, such as human hearing or consumption. For example, speaker(s) 243 work the opposite of microphone(s) 241 where speaker(s) 243 convert electric signals into sound.

Further, input component(s) 231 may further include any number and type of cameras, such as depth-sensing cameras or capturing devices (e.g., Intel® RealSense™ depth-sensing camera) that are known for capturing still and/or video red-green-blue (RGB) and/or RGB-depth (RGB-D) images for media, such as personal media. Such images, having depth information, have been effectively used for various computer vision and computational photography effects, such as (without limitations) scene understanding, refocusing, composition, cinema-graphs, etc. Similarly, for example, displays may include any number and type of displays, such as integral displays, tensor displays, stereoscopic displays, etc., including (but not limited to) embedded or connected display screens, display devices, projectors, etc.

Input component(s) 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more input component(s) 231 may further include one or more of supporting or supplemental devices for capturing and/or sensing of data, such as illuminators (e.g., IR illuminator), light fixtures, generators, sound blockers, etc.

It is further contemplated that in one embodiment, input component(s) 231 may further include any number and type of context sensors (e.g., linear accelerometer) for sensing or detecting any number and type of contexts (e.g., estimating horizon, linear acceleration, etc., relating to a mobile computing device, etc.). For example, input component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, input component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Input component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer“, and/or the like.

Communication/compatibility logic 209 may be used to facilitate dynamic communication and compatibility between various components, networks, computing devices, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, and/or any combination of software and hardware, such as firmware. In one example, “logic” may refer to or include a software component that works with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “neuron”, “neural network”, “multifunction perceptron”, “MP”, “selector neuron”, “extractor neuron”, “splitter neuron”, “transformer neuron”, “mixer neuron”, “counter neuron”, “machine learning interface”, “machine learning model”, “neural network”, “creating”, “training”, “inferencing”, “classifying”, “scoring”, “RealSenseTM camera”, “real-time”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from MP mechanism 110 and/or one or more of MP components 120, 130 of FIG. 1 to facilitate various embodiments including adding, removing, and/or enhancing certain features. For brevity, clarity, and ease of understanding of MP mechanism 110, many of the standard and/or known components, such as those of a computing device, are not shown or discussed here. It is contemplated that embodiments, as described herein, are not limited to any technology, topology, system, architecture, and/or standard and are dynamic enough to adopt and adapt to any future changes.

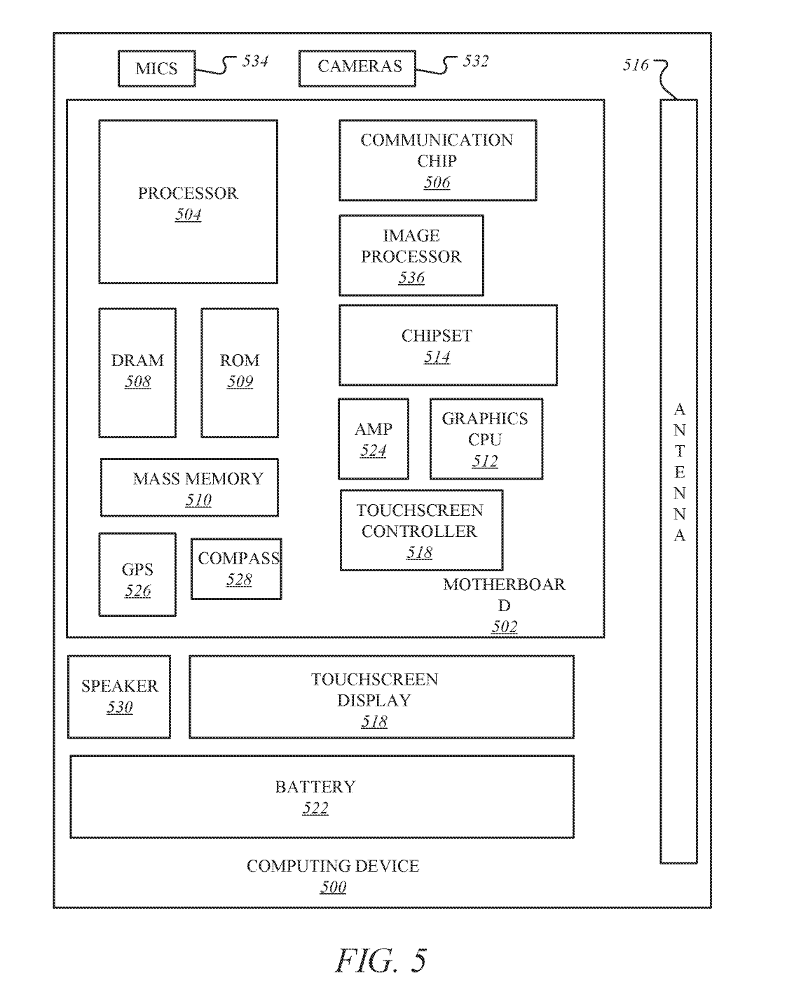

FIG. 5 illustrates a computing device 500 in accordance with one implementation. The illustrated computing device 500 may be same as or similar to computing device 100 of FIG. 1. The computing device 500 houses a system board 502. The board 502 may include a number of components, including but not limited to a processor 504 and at least one communication package 506. The communication package is coupled to one or more antennas 516. The processor 504 is physically and electrically coupled to the board 502.

Depending on its applications, computing device 500 may include other components that may or may not be physically and electrically coupled to the board 502. These other components include, but are not limited to, volatile memory (e.g., DRAM) 508, non-volatile memory (e.g., ROM) 509, flash memory (not shown), a graphics processor 512, a digital signal processor (not shown), a crypto processor (not shown), a chipset 514, an antenna 516, a display 518 such as a touchscreen display, a touchscreen controller 520, a battery 522, an audio codec (not shown), a video codec (not shown), a power amplifier 524, a global positioning system (GPS) device 526, a compass 528, an accelerometer (not shown), a gyroscope (not shown), a speaker 530, cameras 532, a microphone array 534, and a mass storage device (such as hard disk drive) 510, compact disk (CD) (not shown), digital versatile disk (DVD) (not shown), and so forth). These components may be connected to the system board 502, mounted to the system board, or combined with any of the other components.

The communication package 506 enables wireless and/or wired communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 506 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 500 may include a plurality of communication packages 506. For instance, a first communication package 506 may be dedicated to shorter range wireless communications such as Wi-Fi and Bluetooth and a second communication package 506 may be dedicated to longer range wireless communications such as GPS, EDGE, GPRS, CDMA, WiMAX, LTE, Ev-DO, and others.

The cameras 532 including any depth sensors or proximity sensor are coupled to an optional image processor 536 to perform conversions, analysis, noise reduction, comparisons, depth or distance analysis, image understanding, and other processes as described herein. The processor 504 is coupled to the image processor to drive the process with interrupts, set parameters, and control operations of image processor and the cameras. Image processing may instead be performed in the processor 504, the graphics CPU 512, the cameras 532, or in any other device.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 500 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

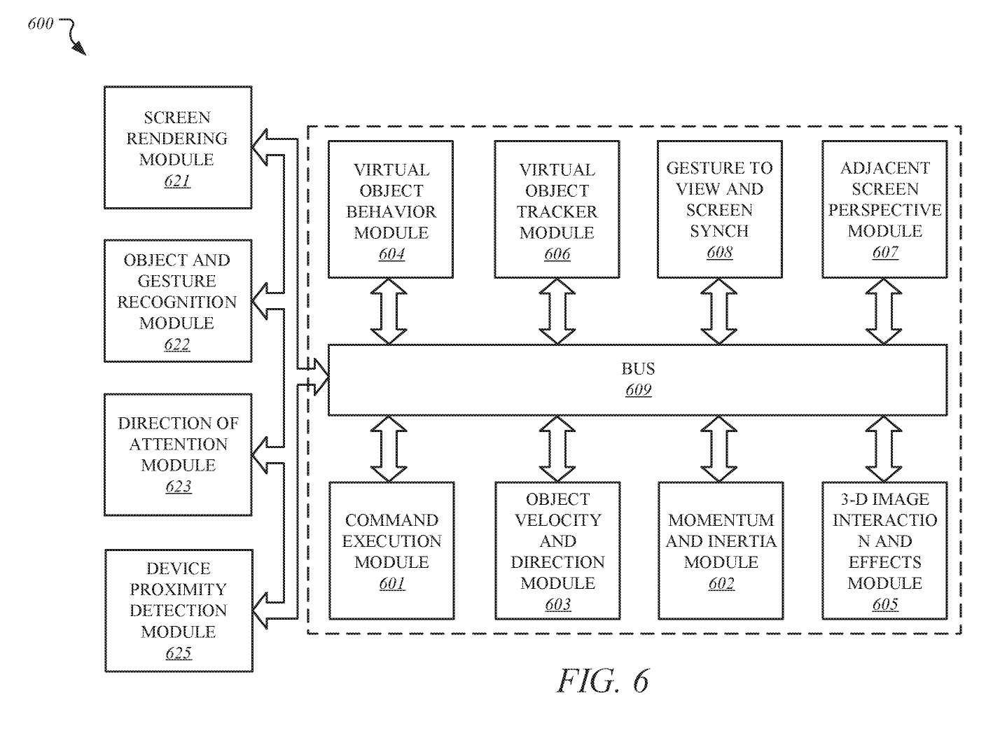

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition Module 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition Module 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition Module 622. Various views of an application on one or more screens can be associated with alternative gesture libraries or a set of gesture templates for a given view. As an example, in FIG. 1A, a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual objects across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition Module 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605, 606, 607, and 608 are connected via an interconnect or a bus, such as bus 609.

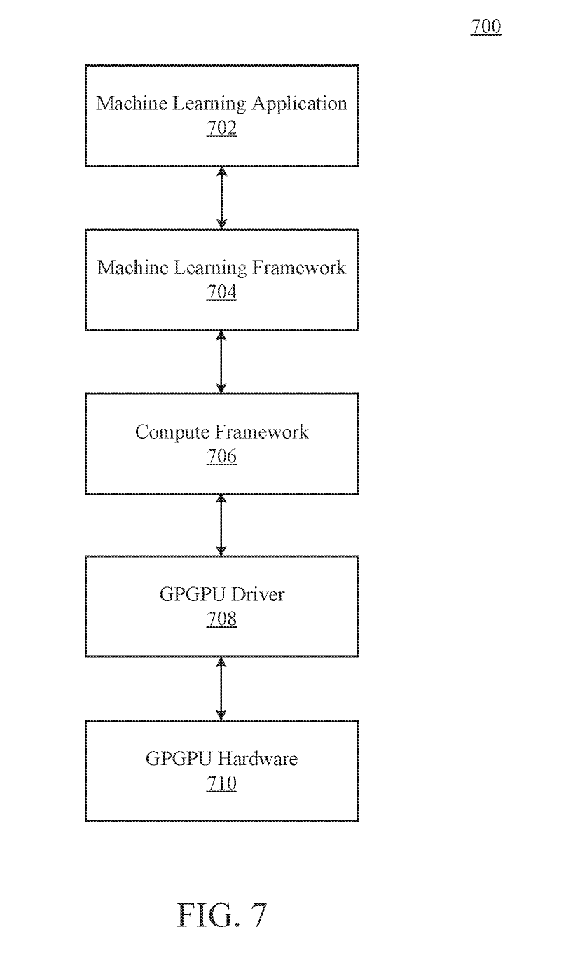

FIG. 7 is a generalized diagram of a machine learning software stack 700. Although FIG. 7 illustrates a software stack for general-purpose GPU (GPGPU) operations, a machine learning software stack is not limited to this example and may include, for also, a machine learning software stack for CPU operations. A machine learning application 702 can be configured to train a neural network using a training dataset or to use a trained deep neural network to implement machine intelligence. The machine learning application 702 can include training and inference functionality for a neural network and/or specialized software that can be used to train a neural network before deployment. The machine learning application 702 can implement any type of machine intelligence including but not limited to image recognition, mapping and localization, autonomous navigation, speech synthesis, medical imaging, or language translation.

Hardware acceleration for the machine learning application 702 can be enabled via a machine learning framework 704. The machine learning framework 704 can provide a library of machine learning primitives. Machine learning primitives are basic operations that are commonly performed by machine learning algorithms Without the machine learning framework 704, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 704. Exemplary primitives include tensor convolutions, activation functions, and pooling, which are computational operations that are performed while training a convolutional neural network (CNN). The machine learning framework 704 can also provide primitives to implement basic linear algebra subprograms performed by many machine-learning algorithms, such as matrix and vector operations.

The machine learning framework 704 can process input data received from the machine learning application 702 and generate the appropriate input to a compute framework 706. The compute framework 706 can abstract the underlying instructions provided to the GPGPU driver 708 to enable the machine learning framework 704 to take advantage of hardware acceleration via the GPGPU hardware 710 without requiring the machine learning framework 704 to have intimate knowledge of the architecture of the GPGPU hardware 710. Additionally, the compute framework 706 can enable hardware acceleration for the machine learning framework 704 across a variety of types and generations of the GPGPU hardware 710.

Machine Learning Neural Network Implementations

The computing architecture provided by embodiments described herein can be trained and learn to perform the types of parallel processing that are computationally equivalent to training and deploying neural networks for machine learning. The computing architecture provided by embodiments described herein differs from Deep Neural Networks (DNNs), Convolutional Neural Networks or Recurrent Neural Networks (RNNs) with respect to both the functionality types of neurons deployed and with respect to the computation steps which the training process comprises. Even though the computing architecture provided differs from neural networks such as CNNs, DNNs or RNNs, some of the computations performed by this architecture may be equivalent to the computations performed by neural networks such as CNNs, DNNs or RNNs. Other computations performed by the computing architecture provided may not be possible if attempted by neural networks such as CNNs, DNNs or RNNs. This is the reason why the computing architecture provided by embodiments described herein addresses the robustness and precision issues associated with neural networks such as CNNs, DNNs or RNNs. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described below present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

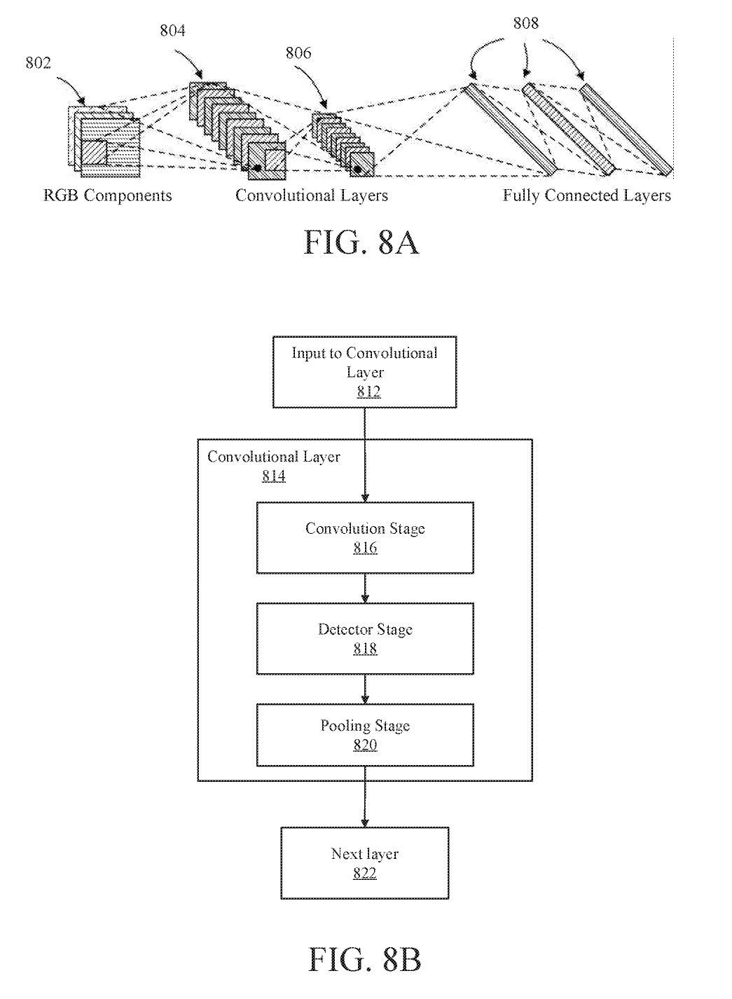

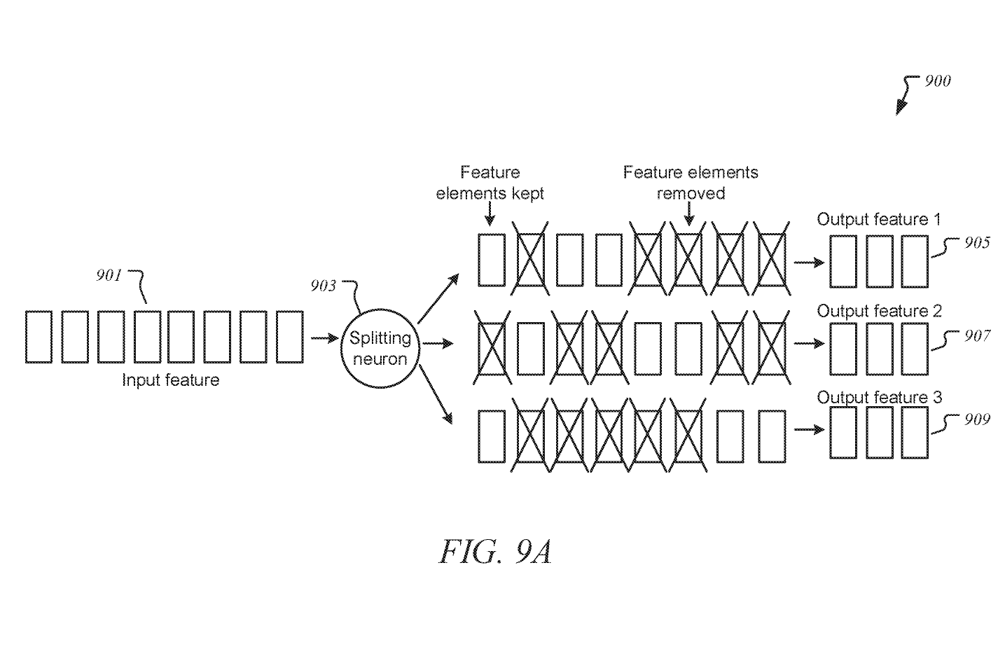

FIGS. 8A-8B illustrate an exemplary convolutional neural network. FIG. 8A illustrates various layers within a CNN. As shown in FIG. 8A, an exemplary CNN used to model image processing can receive input 802 describing the red, green, and blue (RGB) components of an input image. The input 802 can be processed by multiple convolutional layers (e.g., first convolutional layer 804, second convolutional layer 806). The output from the multiple convolutional layers may optionally be processed by a set of fully connected layers 808. Neurons in a fully connected layer have full connections to all activations in the previous layer, as previously described for a feedforward network. The output from the fully connected layers 808 can be used to generate an output result from the network. The activations within the fully connected layers 808 can be computed using matrix multiplication instead of convolution. Not all CNN implementations are make use of fully connected layers 808. For example, in some implementations the second convolutional layer 806 can generate output for the CNN.

The convolutional layers are sparsely connected, which differs from traditional neural network configuration found in the fully connected layers 808. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 8B illustrates exemplary computation stages within a convolutional layer of a CNN. Input to a convolutional layer 812 of a CNN can be processed in three stages of a convolutional layer 814. The three stages can include a convolution stage 816, a detector stage 818, and a pooling stage 820. The convolution layer 814 can then output data to a successive convolutional layer. The final convolutional layer of the network can generate output feature map data or provide input to a fully connected layer, for example, to generate a classification value for the input to the CNN.

In the convolution stage 816 performs several convolutions in parallel to produce a set of linear activations. The convolution stage 816 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 816 defines a set of linear activations that are processed by successive stages of the convolutional layer 814.

The linear activations can be processed by a detector stage 818. In the detector stage 818, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as ƒ(x)=max(0, x), such that the activation is thresholded at zero.

The pooling stage 820 uses a pooling function that replaces the output of the second convolutional layer 806 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 820, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 814 can then be processed by the next layer 822. The next layer 822 can be an additional convolutional layer or one of the fully connected layers 808. For example, the first convolutional layer 804 of FIG. 8A can output to the second convolutional layer 806, while the second convolutional layer can output to a first layer of the fully connected layers 808.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes an apparatus to facilitate multifunction perceptron-based machine learning in computing environments, the apparatus comprising: one or more processors to: generate a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

Example 2 includes the subject matter of Example 1, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

Example 3 includes the subject matter of Examples 1-2, wherein the one or more processors are further to: detect sensor data through the one or more sensors including one or more of a camera, a microphone, a touch sensor, a capacitor, a radio component, a radar component, a scanner, and an accelerometer; and perform the one or more neuron functions on the sensor data as part of a training process using one or more of the plurality of neurons, wherein the plurality of neurons further includes one or more of selector neurons, extractor neurons, and transformer neurons.

Example 4 includes the subject matter of Examples 1-3, wherein the one or more processors are further to: facilitate connectivity within the plurality of neurons through interconnects or buses; and map, physically and logically, the plurality of neurons with the one or more processors through the interconnects or buses.

Example 5 includes the subject matter of Examples 1-4, wherein the one or more processors are further to: perform one or more of supervised learning and unsupervised learning within the multifunction perceptron architecture to optimize parameters used by the plurality of neurons to perform the neuron functions.

Example 6 includes the subject matter of Examples 1-5, wherein the one or more processors are further to: train the multifunction perceptron architecture; extract, based on training, a learned algorithm; optimize the learned algorithm; and build a separate implementation of the learned algorithm.

Example 7 includes the subject matter of Examples 1-6, wherein the one or more processors are further to facilitate competition between multiple algorithms at the multifunction perception architecture, wherein the multiple algorithms are allowed to mutate to improve scores until an algorithm from the multiple algorithms emerges as a winning algorithm, wherein the one or more processors comprising one or more of a graphics processor, an application processor, and another processor, wherein the one or more processors are co-located on a common semiconductor package.

Some embodiments pertain to Example 8 that includes a method facilitating multifunction perceptron-based machine learning in computing environments, the method comprising: generating a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

Example 9 includes the subject matter of Example 8, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

Example 10 includes the subject matter of Examples 8-9, further comprising: detecting sensor data through the one or more sensors including one or more of a camera, a microphone, a touch sensor, a capacitor, a radio component, a radar component, a scanner, and an accelerometer; and performing the one or more neuron functions on the sensor data as part of a training process using one or more of the plurality of neurons, wherein the plurality of neurons further includes one or more of selector neurons, extractor neurons, and transformer neurons.

Example 11 includes the subject matter of Examples 8-10, further comprising: facilitating connectivity within the plurality of neurons through interconnects or buses; and mapping, physically and logically, the plurality of neurons with the one or more processors through the interconnects or buses.

Example 12 includes the subject matter of Examples 8-11, further comprising: performing one or more of supervised learning and unsupervised learning within the multifunction perceptron architecture to optimize parameters used by the plurality of neurons to perform the neuron functions.

Example 13 includes the subject matter of Examples 8-12, further comprising: training the multifunction perceptron architecture; extracting, based on training, a learned algorithm; optimizing the learned algorithm; and building a separate implementation of the learned algorithm.

Example 14 includes the subject matter of Examples 8-13, further comprising facilitating competition between multiple algorithms at the multifunction perception architecture, wherein the multiple algorithms are allowed to mutate to improve scores until an algorithm from the multiple algorithms emerges as a winning algorithm, wherein the method is facilitated at a computing device having one or more processors comprising one or more of a graphics processor, an application processor, and another processor, wherein the one or more processors are co-located on a common semiconductor package.

Some embodiments pertain to Example 15 that includes a data processing system comprising one or more processing devices to: generate a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons; and memory coupled to the one or more processing devices.

Example 16 includes the subject matter of Example 15, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

Example 17 includes the subject matter of Examples 15-16, wherein the one or more processing devices are further to: detect sensor data through the one or more sensors including one or more of a camera, a microphone, a touch sensor, a capacitor, a radio component, a radar component, a scanner, and an accelerometer; and performing the one or more neuron functions on the sensor data as part of a training process using one or more of the plurality of neurons, wherein the plurality of neurons further includes one or more of selector neurons, extractor neurons, and transformer neurons.

Example 18 includes the subject matter of Examples 15-17, wherein the one or more processing devices are further to: facilitate connectivity within the plurality of neurons through interconnects or buses; and mapping, physically and logically, the plurality of neurons with the one or more processors through the interconnects or buses.

Example 19 includes the subject matter of Examples 15-18, wherein the one or more processing devices are further to: perform one or more of supervised learning and unsupervised learning within the multifunction perceptron architecture to optimize parameters used by the plurality of neurons to perform the neuron functions.

Example 20 includes the subject matter of Examples 15-19, wherein the one or more processing devices are further to: train the multifunction perceptron architecture; extracting, based on training, a learned algorithm; optimizing the learned algorithm; and building a separate implementation of the learned algorithm.

Example 21 includes the subject matter of Examples 15-20, wherein the one or more processing devices are further to facilitate competition between multiple algorithms at the multifunction perception architecture, wherein the multiple algorithms are allowed to mutate to improve scores until an algorithm from the multiple algorithms emerges as a winning algorithm, wherein the one or more processors comprising one or more of a graphics processor, an application processor, and another processor, wherein the one or more processors are co-located on a common semiconductor package.

Some embodiments pertain to Example 22 that includes an apparatus facilitating embedding of human labeler influences in machine learning interfaces in computing environments, the apparatus comprising: means for generating a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

Example 23 includes the subject matter of Example 22, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

Example 24 includes the subject matter of Examples 22-23, further comprising: means for detecting sensor data through the one or more sensors including one or more of a camera, a microphone, a touch sensor, a capacitor, a radio component, a radar component, a scanner, and an accelerometer; and means for performing the one or more neuron functions on the sensor data as part of a training process using one or more of the plurality of neurons, wherein the plurality of neurons further includes one or more of selector neurons, extractor neurons, and transformer neurons.

Example 25 includes the subject matter of Examples 22-24, further comprising: means for facilitating connectivity within the plurality of neurons through interconnects or buses; and means for mapping, physically and logically, the plurality of neurons with the one or more processors through the interconnects or buses.

Example 26 includes the subject matter of Examples 22-25, further comprising: means for performing one or more of supervised learning and unsupervised learning within the multifunction perceptron architecture to optimize parameters used by the plurality of neurons to perform the neuron functions.

Example 27 includes the subject matter of Examples 22-26, further comprising: means for training the multifunction perceptron architecture; means for extracting, based on training, a learned algorithm; means for optimizing the learned algorithm; and means for building a separate implementation of the learned algorithm.

Example 28 includes the subject matter of Examples 22-27, further comprising means for facilitating competition between multiple algorithms at the multifunction perception architecture, wherein the multiple algorithms are allowed to mutate to improve scores until an algorithm from the multiple algorithms emerges as a winning algorithm, wherein the method is facilitated at a computing device having one or more processors comprising one or more of a graphics processor, an application processor, and another processor, wherein the one or more processors are co-located on a common semiconductor package.

Example 29 includes at least one non-transitory or tangible machine-readable medium comprising a plurality of instructions, when executed on a computing device, to implement or perform a method as claimed in any of claims or examples 8-14.

Example 30 includes at least one machine-readable medium comprising a plurality of instructions, when executed on a computing device, to implement or perform a method as claimed in any of claims or examples 8-14.

Example 31 includes a system comprising a mechanism to implement or perform a method as claimed in any of claims or examples 8-14.

Example 32 includes an apparatus comprising means for performing a method as claimed in any of claims or examples 8-14.

Example 33 includes a computing device arranged to implement or perform a method as claimed in any of claims or examples 8-14.

7S ; D:142;i0-US

Example 34 includes a communications device arranged to implement or perform a method as claimed in any of claims or examples 8-14.

Example 35 includes at least one machine-readable medium comprising a plurality of instructions, when executed on a computing device, to implement or perform a method or realize an apparatus as claimed in any preceding claims.

Example 36 includes at least one non-transitory or tangible machine-readable medium comprising a plurality of instructions, when executed on a computing device, to implement or perform a method or realize an apparatus as claimed in any preceding claims.

Example 37 includes a system comprising a mechanism to implement or perform a method or realize an apparatus as claimed in any preceding claims.

Example 38 includes an apparatus comprising means to perform a method as claimed in any preceding claims.

Example 39 includes a computing device arranged to implement or perform a method or realize an apparatus as claimed in any preceding claims.

Example 40 includes a communications device arranged to implement or perform a method or realize an apparatus as claimed in any preceding claims.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. At least one machine-readable medium comprising instructions which, when executed by a computing device, cause the computing device to perform operations comprising:
generating a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

2. The machine-readable medium of claim 1, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

3. The machine-readable medium of claim 1, wherein the operations further comprise:
detecting sensor data through the one or more sensors including one or more of a camera, a microphone, a touch sensor, a capacitor, a radio component, a radar component, a scanner, and an accelerometer; and
performing the one or more neuron functions on the sensor data as part of a training process using one or more of the plurality of neurons, wherein the plurality of neurons further includes one or more of selector neurons, extractor neurons, and transformer neurons.

4. The machine-readable medium of claim 3, wherein the operations further comprise:
facilitating connectivity within the plurality of neurons through interconnects or buses; and
mapping, physically and logically, the plurality of neurons with the one or more processors through the interconnects or buses.

5. The machine-readable medium of claim 1, wherein the operations further comprise:
performing one or more of supervised learning and unsupervised learning within the multifunction perceptron architecture to optimize parameters used by the plurality of neurons to perform the neuron functions.

6. The machine-readable medium of claim 5, wherein the operations further comprise:
training the multifunction perceptron architecture;
extracting, based on training, a learned algorithm;
optimizing the learned algorithm; and
building a separate implementation of the learned algorithm.

7. The machine-readable medium of claim 1, wherein the operations further comprise facilitating competition between multiple algorithms at the multifunction perception architecture, wherein the multiple algorithms are allowed to mutate to improve scores until an algorithm from the multiple algorithms emerges as a winning algorithm, wherein the one or more processors comprising one or more of a graphics processor, an application processor, and another processor, wherein the one or more processors are co-located on a common semiconductor package.

8. A method comprising:
generating a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

9. The method of claim 8, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

10. The method of claim 8, further comprising:
detecting sensor data through the one or more sensors including one or more of a camera, a microphone, a touch sensor, a capacitor, a radio component, a radar component, a scanner, and an accelerometer; and
performing the one or more neuron functions on the sensor data as part of a training process using one or more of the plurality of neurons, wherein the plurality of neurons further includes one or more of selector neurons, extractor neurons, and transformer neurons.

11. The method of claim 10, further comprising:
facilitating connectivity within the plurality of neurons through interconnects or buses; and
mapping, physically and logically, the plurality of neurons with the one or more processors through the interconnects or buses.

12. The method of claim 8, further comprising:
performing one or more of supervised learning and unsupervised learning within the multifunction perceptron architecture to optimize parameters used by the plurality of neurons to perform the neuron functions.

13. The method of claim 12, further comprising:
training the multifunction perceptron architecture;
extracting, based on training, a learned algorithm;
optimizing the learned algorithm; and
building a separate implementation of the learned algorithm.

14. The method of claim 8, further comprising facilitating competition between multiple algorithms at the multifunction perception architecture, wherein the multiple algorithms are allowed to mutate to improve scores until an algorithm from the multiple algorithms emerges as a winning algorithm, wherein the one or more processors comprising one or more of a graphics processor, an application processor, and another processor, wherein the one or more processors are co-located on a common semiconductor package.

15. An apparatus comprising:
one or more processors to:
generate a multifunction perceptron architecture having a plurality of neurons to perform one or more neuron functions in a machine learning environment, wherein the plurality of neurons includes one or more of splitter neurons, mixer neurons, and counter neurons, wherein the plurality of neurons include heterogenous neurons.

16. The apparatus of claim 15, wherein the plurality of neurons comprises one or more of software threads and hardware threads, wherein the software threads are facilitated by one or more processors including homogenous processor or heterogenous processors, wherein the hardware threads are associated with the one or more processors through hardware sequential logic, wherein the counter neurons to facilitate discovery of salient features that characterize classes by counting a number of extracted features appearing in training data and paths that describe a flow of information between the heterogenous neurons and competing algorithms

17. The apparatus of claim 16, wherein the one or more processors are further to:
detect sensor data through the one or more sensors including one or more of a camera, a microphone, a touch sensor, a capacitor, a radio component, a radar component, a scanner, and an accelerometer; and
perform the one or more neuron functions on the sensor data as part of a training process using one or more of the plurality of neurons, wherein the plurality of neurons further includes one or more of selector neurons, extractor neurons, and transformer neurons.

18. The apparatus of claim 17, wherein the one or more processors are further to:
facilitate connectivity within the plurality of neurons through interconnects or buses; and
map, physically and logically, the plurality of neurons with the one or more processors through the interconnects or buses.

19. The apparatus of claim 15, wherein the one or more processors are further to:
perform one or more of supervised learning and unsupervised learning within the multifunction perceptron architecture to optimize parameters used by the plurality of neurons to perform the neuron functions.

20. The apparatus of claim 19, wherein the one or more processors are further to:
train the multifunction perceptron architecture;
extract, based on training, a learned algorithm;
optimize the learned algorithm; and
build a separate implementation of the learned algorithm.

21. The apparatus of claim 15, wherein the one or more processors are further to facilitate competition between multiple algorithms at the multifunction perception architecture, wherein the multiple algorithms are allowed to mutate to improve scores until an algorithm from the multiple algorithms emerges as a winning algorithm, wherein the one or more processors comprising one or more of a graphics processor, an application processor, and another processor, wherein the one or more processors are co-located on a common semiconductor package.
